(19) United States
(12) Patent Application Publication
(10) Pub. No.: US 2017/0145943 A1
(43) Pub. Date: May 25, 2017

(54) FUEL INJECTION CONTROL APPARATUS FOR INTERNAL COMBUSTION ENGINE

(71) Applicant: TOYOTA JIDOSHA KABUSHIKI KAISHA, Toyota-shi, Aichi-ken (JP)

(72) Inventors: Shinichi MITANI, Susono-shi (JP); Daisuke UCHIDA, Gotenba-shi (JP); Naoya KANEKO, Gotenba-shi (JP); Kenji HOSHI, Gotenba-shi (JP); Hiroaki ADACHI, Ashigarakami-gun (JP); Susumu HASHIMOTO, Susono-shi (JP)

(73) Assignee: TOYOTA JIDOSHA KABUSHIKI KAISHA, Toyota-shi, Aichi-ken (JP)

(21) Appl. No.: 15/309,937

(22) PCT Filed: May 13, 2015
(86) PCT No.: PCT/IB2015/000677

§ 371 Date: Nov. 9, 2016

(30) Foreign Application Priority Data
May 15, 2014 (JP) 2014-101265

(51) Int. Cl. F02D 41/30; F02F 3/28; F02D 41/40

(52) U.S. Cl. CPC F02D 41/3023; F02D 41/402; F02F 3/28; F02D 2041/389

(57) ABSTRACT

In an in-cylinder injection spark-ignition internal combustion engine, in which fuel is injected toward a cavity formed in a crown surface of a piston, when split injection for dividing and injecting the fuel for plural times is performed during a compression stroke, an arrival lift amount that is a maximum value of displacement of a valve body of a fuel injection valve during fuel injection is set as a larger value at least in a first period as a crank angle of the internal combustion engine approaches compression top dead center.

### BACKGROUND OF THE INVENTION

1. Field of the Invention

The invention relates to a fuel injection control apparatus for an in-cylinder injection spark-ignition internal combustion engine in which fuel is injected toward a cavity formed in a crown surface of a piston.

2. Description of Related Art

It has been known to directly inject fuel into a cylinder and produce air-fuel mixture with favorable ignitability at a time point of ignition in the vicinity of an ignition plug, so as to perform stratified charge combustion. In the stratified charge combustion, lean air-fuel mixture can be combusted in the entire cylinder. This is effective in improvement of a fuel consumption rate. In the general stratified charge combustion, a fuel injection valve is opened for a period that is required to inject a necessary fuel amount from time at which fuel injection is initiated and which is set in a latter half of a compression stroke. The fuel that is injected just as described enters a cavity formed in the piston (hereinafter may be referred to as a “piston cavity”). Then, the injected fuel draws heat from a wall surface of a combustion chamber, and is vaporized while being deflected in a direction toward a spark plug due to a shape of an inner wall of the piston cavity. Accordingly, the air-fuel mixture with the favorable ignitability is produced in the vicinity of the ignition plug.

However, if a fuel injection amount is increased in accordance with an increase in a necessary fuel amount at a high load or the like, for example, a period that is required for the injected fuel to be vaporized by the heat from the wall surface of the combustion chamber and to produce combustible air-fuel mixture is extended. In order to secure this period, time at which the fuel injection is terminated has to be set earlier. As a result, a fuel amount that can be injected in the latter half of the compression stroke is reduced by necessity. For this reason, it is difficult to perform the stratified charge combustion when the necessary fuel amount becomes equal to or larger than a certain amount. Meanwhile, since the stratified charge combustion is effective in improvement of the fuel consumption rate, as described above, it has been desired to perform the stratified charge combustion under a further wide range of an engine operation status.

In view of the above, it has been suggested to use a fuel injection valve with a slit-shaped injection hole, so as to inject the fuel as fan-shaped spray. The thus-injected fuel as the fan-shaped spray can draw heat from a wider area of the inner wall of the piston cavity. Accordingly, the combustible air-fuel mixture can be produced in a short period. Thus, compared to a case where a fuel injection valve with a general injection hole is used to inject the fuel as conical spray, the time at which the fuel injection is terminated can be delayed. For this reason, the fuel amount that can be injected in the latter half of the compression stroke can be increased. According to such a technique, a stratified charge combustion region can be expanded to a high load side (see Japanese Patent Application Publication No. 09-158736 (JP 09-158736 A), for example).

As described above, various techniques have been suggested to secure reliable ignitability and allow expansion of the stratified charge combustion region to the high load side in the in-cylinder injection spark-ignition internal combustion engine that includes the piston cavity. Despite this fact, it is still difficult to secure stable stratified charge combustion in some cases.

### SUMMARY OF THE INVENTION

The fuel injection valve in the in-cylinder injection spark-ignition internal combustion engine, which includes the piston cavity and has a purpose of performing the stratified charge combustion, injects the fuel toward the piston cavity in a direction that defines a certain angle with respect to a direction of vertical motion of the piston. The inner wall of the piston cavity is formed in such a shape that the fuel spray, which is injected just as described and enters the piston cavity, is deflected in the direction toward the spark plug in accordance with the shape of the inner wall of the piston cavity (see FIG. 18B).

However, as indicated by an arrow in FIG. 18A, in the case where the fuel spray with large momentum (a penetration force) (that is, at a high speed) is injected when a distance between the fuel injection valve and the piston is long, the fuel spray may not be able to enter the piston cavity. The fuel spray that cannot enter the piston cavity, just as described, is not deflected in the direction toward the spark plug by the piston cavity. Accordingly, the air-fuel mixture with the favorable ignitability cannot be produced in the vicinity of the spark plug. As a result, the stratified charge combustion may be unstabilized.

In view of the above, the inventor has reached an idea as a result of earnest researches that the stable stratified charge combustion can be secured by adjusting the momentum (the penetration force) of the fuel spray, which is injected from the fuel injection valve, in accordance with the distance between the fuel injection valve and the piston. More specifically, the inventor has found that the stable stratified charge combustion can be secured by performing so-called “partial lift injection” at an early stage of injection in the compression stroke, at which the distance between the fuel injection valve and the piston is long. The partial lift injection means that the fuel is injected by reducing a maximum value of displacement (that is, an arrival lift amount) of a valve body at a time when the fuel injection valve injects the fuel to be smaller than usual. In the partial lift amount, the momentum (the penetration force) of the fuel spray that is injected from the fuel injection valve can be reduced.

A fuel injection control apparatus for an in-cylinder injection spark-ignition internal combustion engine according to an aspect of the invention, the in-cylinder injection spark-ignition internal combustion engine includes: a piston that is provided with a cavity in a crown surface; and a fuel injection valve that is configured to inject fuel from an injection hole toward the cavity in conjunction with movement of a valve body from a valve seat. The fuel injection control apparatus includes an electronic control unit. The electronic control unit is configured to i) move the valve body and change an arrival lift amount that is a maximum value of displacement of the valve body; ii) control the fuel injection valve such that split injection in which the fuel is divided and injected for a plurality of times is executed at least in a first period of a compression stroke of the internal combustion engine; and iii) set the arrival lift amount such that the arrival lift amount for each injection in the first period increases as a crank angle of the internal combustion engine approaches compression top dead center.

As described above, in the fuel injection control apparatus according to the one aspect of the invention, the fuel is injected by the split injection at least in the first period of the compression stroke of the internal combustion engine, and the arrival lift amount of the valve body of the fuel injection valve is set as a smaller value as time is closer to an early stage of the first period. In other words, at least the injection at the early stage of the first period is performed in a form of the partial lift injection. In this way, in the case where a distance between the fuel injection valve and the piston is relatively long, momentum (a penetration force) of fuel spray that is injected from the fuel injection valve is small (see FIG. 8B). As a result, a fuel spray amount that cannot enter a piston cavity is reduced as described above, and a fuel spray amount for producing combustible air-fuel mixture with favorable combustibility in the vicinity of an ignition plug is increased. In this way, stable stratified charge combustion can be secured.

Furthermore, in another aspect of the invention, the electronic control unit may be configured to i) cause the fuel injection valve to inject the fuel at least once in a second period prior to the first period; and ii) set the arrival lift amount such that the arrival lift amount for each injection in the second period is smaller than the arrival lift amount for an initial injection in the first period. According to this, the fuel that is injected in the second period prior to the first period has the extremely small momentum. Such fuel spray does not travel throughout a “combustion chamber that has a large volume due to the long distance between the piston and the fuel injection valve”. Rather, at least some (desirably more) of the fuel spray is likely to remain in the vicinity of the fuel injection valve (an upper section of the combustion chamber). For this reason, the fuel injected in the second period is likely to be caught in the piston cavity when the piston is elevated later, and thus can contribute to production of the combustible air-fuel mixture with the favorable combustibility. As a result, a larger fuel amount can be used to produce the combustible air-fuel mixture.

Meanwhile, the distance between the fuel injection valve and the piston is short at a final stage of the fuel injection in the compression stroke (hereinafter may be referred to as the “injection in the compression stroke”). For this reason, the fuel spray with the large momentum (the penetration force), which is immediately after being injected from the fuel injection valve, hits the crown surface of the piston. Thus, a so-called “fuel wet” state, in which the crown surface of the piston and/or the inner wall of the piston cavity gets wet by the fuel, may be generated. If such a fuel wet state is generated, smoke, a particle matter (PM), and the like, for example, may be produced.

In view of the above, in yet another aspect of the invention, the electronic control unit may be configured to i) cause the fuel injection valve to inject the fuel at least once in a third period after the first period; and ii) maintain the arrival lift amount for each injection in the third period at a prescribed value. According to this, it is possible to avoid the arrival lift amount from being set as a larger value at the final stage of the injection in the compression stroke, at which the distance between the fuel injection valve and the piston is short. As a result, as described above, a fuel amount that wets the crown surface of the piston and/or the inner wall of the piston cavity (hereinafter may be referred to as a “wet amount”) is suppressed from increasing. Thus, a chance of generation of the smoke, the PM, and the like, for example, is reduced.

Alternatively, in further another aspect of the invention, the electronic control unit may be configured to i) cause the fuel injection valve to inject the fuel at least once in the third period after the first period; and ii) set the arrival lift amount such that the arrival lift amount for the each injection in the third period reduces as the crank angle of the internal combustion engine approaches compression top dead center. According to this, the arrival lift amount is set as a smaller value as the time is closer to the final stage of the injection in the compression stroke, at which the distance between the fuel injection valve and the piston is short. As a result, the wet amount is further reliably suppressed from increasing, and the chance of generation of the smoke, the PM, and the like, for example, is further reliably reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of an internal combustion engine, to which a fuel injection control apparatus according to one embodiment (a first mode) of the invention is applied;

FIG. 2 is a cross-sectional view of a fuel injection valve that is shown in FIG. 1;

FIG. 3 is a cross-sectional view of a tip of the fuel injection valve that is shown in FIG. 2 when the fuel injection valve stops injection;

FIG. 4 is a cross-sectional view of the tip of the fuel injection valve that is shown in FIG. 2 when said fuel injection valve performs high lift injection;

FIG. 5 is a cross-sectional view of the tip of the fuel injection valve that is shown in FIG. 2 when said fuel injection valve performs low lift injection;

FIG. 6A is a schematic graph for showing a temporal change of a needle lift amount in maximum lift injection, and FIG. 6B is a schematic graph for showing a temporal change of the needle lift amount in the low lift injection;

FIG. 7 is a schematic graph for showing transitions of a position of a piston, a lift amount of the fuel injection valve, and momentum (a penetration force) of fuel spray that is injected from the fuel injection valve with respect to a crank angle in the case where split injection is performed in a compression stroke of the engine by the fuel injection control apparatus according to the first mode;

FIG. 8A, FIG. 8B, and FIG. 8C are schematic views of statuses of the fuel spray and the positions of the piston at an early stage, an intermediate stage 1, and an intermediate stage 2 of the injection in the compression stroke by the fuel injection control apparatus according to the first mode, respectively;

FIG. 9 is a flowchart for illustrating a flow of various routines that are executed in a fuel injection control flow in the first mode;

FIG. 10A, FIG. 10B, FIG. 10C, and FIG. 10D are schematic views of the statuses of the fuel spray and the positions of the piston at the early stage, the intermediate stage 1, the intermediate stage 2, and a late stage, respectively, in the case where a fuel injection amount is kept increased in the compression stroke;

FIG. 11 is a schematic graph for showing the transitions of the position of the piston, the lift amount of the fuel injection valve, and the momentum (the penetration force) of the fuel spray that is injected from the fuel injection valve with respect to the crank angle in the case where the split injection is performed in the compression stroke of the engine by the fuel injection control apparatus according to a third embodiment (a third mode) of the invention;

FIG. 12A, FIG. 12B, FIG. 12C, and FIG. 12D are schematic views of the statuses of the fuel spray and the positions of the piston at the early stage, the intermediate stage 1, the intermediate stage 2, and the late stage of the injection in the compression stroke by the fuel injection control apparatus according to the third mode, respectively;

FIG. 13 is a flowchart for illustrating a flow of various routines that are executed in the fuel injection control flow in the third mode;

FIG. 14 is a schematic graph for showing the transitions of the position of the piston, the lift amount of the fuel injection valve, and the momentum (the penetration force) of the fuel spray that is injected from the fuel injection valve with respect to the crank angle in the case where the split injection is performed in the compression stroke of the engine by the fuel injection control apparatus according to a fourth embodiment (a fourth mode) of the invention;

FIG. 15A, FIG. 15B, FIG. 15C, FIG. 15D, and FIG. 15E are schematic views of the statuses of the fuel spray and the positions of the piston at the early stage, the intermediate stage 1, the intermediate stage 2, a late stage 1, and a late stage 2 of the injection in the compression stroke by the fuel injection control apparatus according to the fourth mode, respectively;

FIG. 16 is a flowchart for illustrating a flow of various routines that are executed in the fuel injection control flow in the fourth mode;

FIG. 17 is a schematic graph for showing the transitions of the position of the piston, the lift amount of the fuel injection valve, and the momentum (the penetration force) of the fuel spray that is injected from the fuel injection valve with respect to the crank angle in the case where the split injection is performed in the compression stroke of the engine by the fuel injection control apparatus according to conventional art; and

FIG. 18A and FIG. 18B are schematic view of the statuses of the fuel spray and the positions of the piston at the early stage and the intermediate stage of the injection in the compression stroke by the fuel injection control apparatus according to the conventional art.

### DETAILED DESCRIPTION OF EMBODIMENTS

As described above, according to the fuel injection control apparatus according to the invention, the reliable combustibility is secured in the in-cylinder injection spark-ignition internal combustion engine, which includes the piston cavity, and thus the stable stratified charge combustion can be secured. More specifically, in the fuel injection control apparatus according to the invention, the momentum (the penetration force) of the fuel spray that is injected from the fuel injection valve is reduced by performing the partial lift injection at the early stage of the injection in the compression stroke, at which the distance between the fuel injection valve and the piston is long. As a result, the combustible air-fuel mixture with the favorable combustibility can be produced in the vicinity of the ignition plug. Thus, the stable stratified charge combustion can be secured. A detailed description will hereinafter be made on some modes for carrying out the invention.

### First Embodiment

First, a first embodiment (hereinafter may be referred to as a “first mode”) of the invention is a fuel injection control apparatus for an in-cylinder injection spark-ignition internal combustion engine. The fuel injection control apparatus is applied to an internal combustion engine that includes a piston. The piston is formed with a cavity in a crown surface. The fuel injection control apparatus includes: a fuel injection valve that injects fuel from an injection hole toward the cavity in conjunction with movement of a valve body from a valve seat; and a control section that moves the valve body to inject the fuel from the fuel injection valve and can increase/reduce an arrival lift amount that is a maximum value of displacement of said valve body. In the fuel injection control apparatus, the control section instructs the fuel injection valve to perform split injection, in which the fuel is divided and injected for plural times at least in a first period of compression stroke of the internal combustion engine. The control section also sets the arrival lift amount for each injection in the same first period as a larger value as a crank angle of the internal combustion engine approaches compression top dead center.

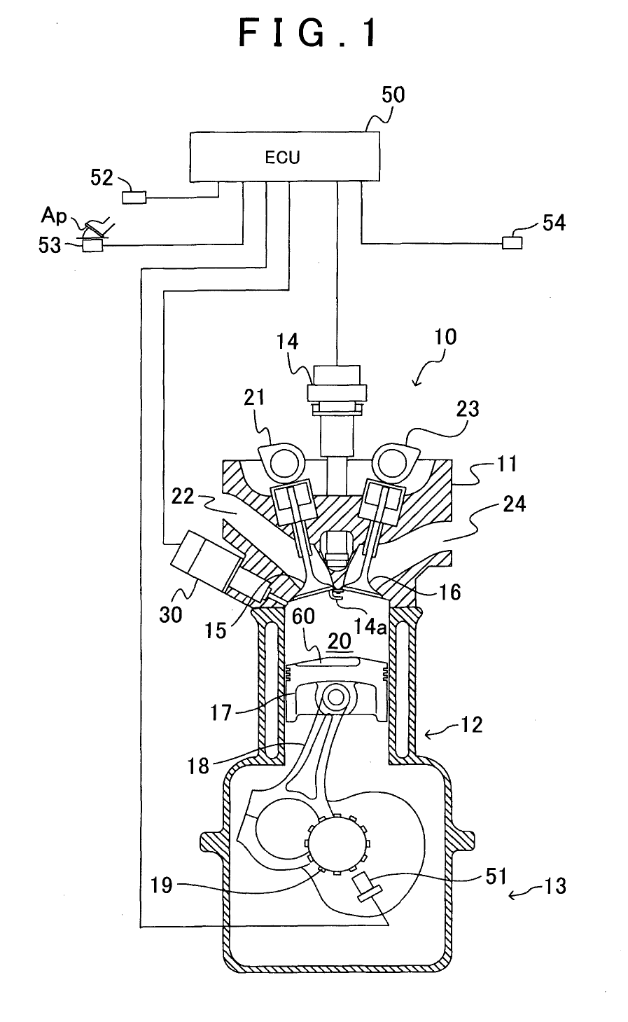

As described above, the fuel injection control apparatus according to the first mode is applied to the internal combustion engine, which includes the piston formed with the cavity in the crown surface. In addition, the fuel injection control apparatus according to the first mode is the fuel injection control apparatus for the in-cylinder injection spark-ignition internal combustion engine, the fuel injection control apparatus including: the fuel injection valve that injects the fuel from the injection hole toward the cavity in conjunction with the movement of the valve body from the valve seat; and the control section that moves the valve body to inject the fuel from the fuel injection valve and can increase/reduce the arrival lift amount that is the maximum value of displacement of said valve body. Here, a detailed description will be made on configurations of the internal combustion engine, to which the fuel injection control apparatus according to the first mode is applied, the fuel injection valve, the control section, and the like with reference to FIG. 1.

(Configuration of the internal combustion engine) An engine 10 is a well-known engine of gasoline fuel spark ignition type. The engine 10 includes a cylinder head 11, a cylinder block 12, a crank case 13, an igniter 14 including an ignition plug, an intake valve 15, an exhaust valve 16, a piston 17, a connecting rod 18, a crankshaft 19, and the like. A combustion chamber 20 is formed by a lower wall surface of the cylinder head 11, a wall surface of a cylinder bore that is formed by the cylinder block 12, and a crown surface of the piston 17. As described above, the crown surface of the piston 17 is formed with the cavity (a piston cavity 60).

As described above, the fuel spray, which is injected from a fuel injection valve 30, is appropriately guided into the piston cavity 60 and deflected in the direction toward the spark plug in accordance with a shape of an inner wall of the piston cavity 60. In this way, the air-fuel mixture with the favorable ignitability is produced in the vicinity of a spark generating section 14a of the ignition plug. Accordingly, the stratified charge combustion is realized.

The igniter 14 is disposed in the cylinder head 11 such that the spark generating section 14a of the ignition plug is exposed to a central section of an upper surface of the combustion chamber 20. The intake valve 15 is disposed in the cylinder head 11 and driven by an intake cam 21, so as to open or close “a communicating section between the combustion chamber 20 and an intake port 22, the intake port 22 being formed in the cylinder head 11”. The exhaust valve 16 is disposed in the cylinder head 11 and driven by an exhaust cam 23, so as to open or close “a communicating section between the combustion chamber 20 and an exhaust port 24, the exhaust port 24 being formed in the cylinder head 11”. Furthermore, the engine 10 includes the fuel injection valve (in-cylinder injection valve) 30. The fuel injection valve 30 is disposed in “a region between the intake port 22 of the cylinder head 11 and the cylinder block 12”, so as to inject the fuel into the combustion chamber 20.

Noted that, as described above, the internal combustion engine shown in FIG. 1 is a so-called “internal combustion engine of side injection type”. In the internal combustion engine of the side injection type, the fuel injection valve, which is disposed in the region between the intake port of the cylinder head and the cylinder block, injects the fuel toward a center axis of the cylinder. However, the internal combustion engine, to which the fuel injection control apparatus according to the invention is applied, is not particularly limited as long as the internal combustion engine is the in-cylinder injection spark-ignition internal combustion engine, in which the fuel is injected toward the cavity formed in the crown surface of the piston. In other words, the fuel injection control apparatus according to the invention can be applied not only to the “internal combustion engine of the side injection type” but also to a so-called “internal combustion engine of center injection type”, for example, in which the fuel is injected from the fuel injection valve toward the cavity formed in the crown surface of the piston, the fuel injection valve being disposed in the vicinity of a central section of the cylinder head.

(Configuration of the control section) The fuel injection control apparatus according to the first mode includes an electronic control unit (ECU) 50 that has a well-known microcomputer. The microcomputer includes a CPU, a ROM, a RAM, a backup RAM, and the like. The ECU 50 is electrically connected to the igniter 14, the fuel injection valve 30, and the like, and transmits a drive signal to these components. That is, the ECU 50 corresponds to the control section. In addition, the ECU 50 is electrically connected to a crank position sensor 51, an airflow meter 52, an accelerator pedal depression amount sensor 53, an air-fuel ratio sensor 54, and the like, and receives signals from these sensors.

The crank position sensor 51 generates a signal in accordance with a rotating position of the crankshaft 19. The ECU 50 computes an engine speed NE on the basis of the signal from the crank position sensor 51. Furthermore, on the basis of the signals from the crank position sensor 51 and a cam position sensor (not shown), the ECU 50 obtains an absolute crank angle with compression top dead center in any cylinder being a reference, for example. The airflow meter 52 generates a signal indicative of a flow rate of the intake air in the engine 10. The accelerator pedal depression amount sensor 53 generates a signal indicative of a depression amount of an accelerator pedal Ap. The air-fuel ratio sensor 54 generates a signal indicative of an air-fuel ratio of exhaust gas.

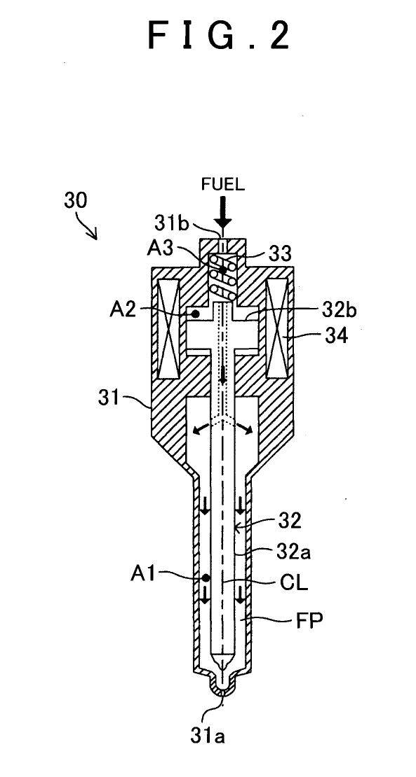

(Configuration of the fuel injection valve) Next, a detailed description will be made on the fuel injection valve 30. As described above, the fuel injection valve 30 injects the fuel, which produces the air-fuel mixture to be supplied to the combustion chamber 20 of the engine 10, from the injection hole in conjunction with the movement of the valve body from the valve seat. The fuel injection valve 30 is an injection valve of so-called inner opening valve type. As shown in FIG. 2, the fuel injection valve 30 has a nozzle main body section 31, a needle valve 32 as the valve body, a spring 33, and a solenoid 34.

The nozzle main body section 31 is formed with a cylindrical space A1, a cylindrical space A2, and a cylindrical space A3. All of these spaces are coaxially formed and communicate with each other. An injection hole 31a that communicates between the cylindrical space A1 and the outside is formed at a tip of the nozzle main body section 31. A fuel intake hole 31b that communicates between the cylindrical space A3 and fuel piping (not shown) is formed at a proximal end of the nozzle main body section 31.

The needle valve 32 has a cylindrical section 32a and a flange section 32b. The cylindrical section 32a has a cylindrical shape with a small diameter. The flange section 32b has a cylindrical shape with a large diameter. A tip of the cylindrical section 32a has a substantially conical shape. The tip side of the cylindrical section 32a is housed in the cylindrical space A1. As a result, a fuel passage FP is formed between an inner peripheral wall surface of a tip side section of the nozzle main body section 31 and an outer peripheral wall surface of a tip side section of the cylindrical section 32a. The flange section 32b is housed in the cylindrical space A2. The needle valve 32 moves along a needle valve axis CL. Furthermore, a “fuel passage that communicates between a proximal end of the needle valve 32 and the outer peripheral wall surface of the tip side section of the cylindrical section 32a” is formed in the needle valve 32. As a result, the fuel that flows from the fuel intake hole 31b into the cylindrical space A3 passes through this fuel passage in the needle valve 32 and is supplied to the fuel passage FP.

The spring 33 is arranged in the cylindrical space A3. The spring 33 urges the needle valve 32 to the injection hole 31a side. The solenoid 34 is disposed in a proximal end side section of the nozzle main body section 31 and also disposed around the cylindrical space A2. The solenoid 34 is brought into an energized state by the drive signal from the ECU 50. In this case, the solenoid 34 generates a magnetic force that moves the needle valve 32 to the fuel intake hole 31b side against an urging force of the spring 33.

When the solenoid 34 is in an unenergized state, displacement of the needle valve 32 (hereinafter may be referred to as a “needle lift amount” or may simply be referred to as a “lift amount”) is “zero”. At this time, the fuel injection is not performed as will be described in detail below. When the solenoid 34 is brought into the energized state and the needle lift amount becomes larger than “zero”, the fuel injection is performed. When the needle lift amount becomes a specified amount, the flange section 32b abuts against a wall section that forms the cylindrical space A2 of the nozzle main body section 31. As a result, movement of the needle valve 32 is restricted. The needle lift amount at this time is referred to as a “maximum lift amount”. In other words, the needle lift amount can vary within a range from “zero” to “the maximum lift amount”.

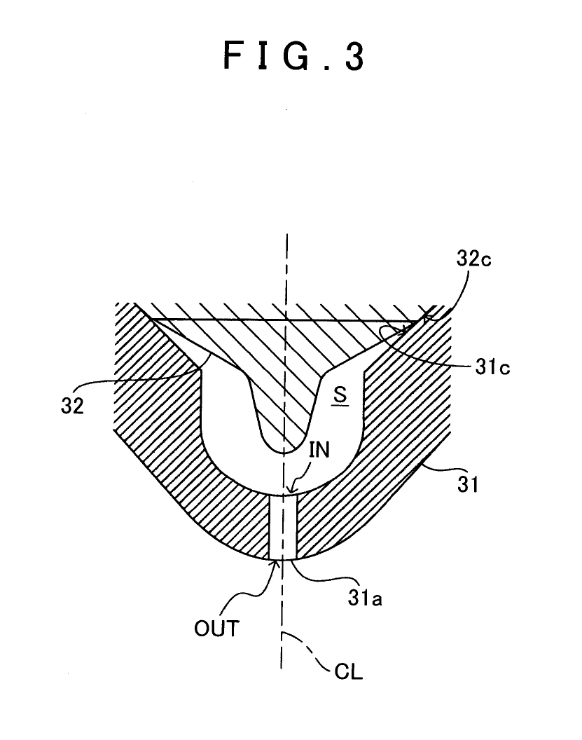

(Operation of the fuel injection valve) Here, a detailed description will be made on an operation of the fuel injection valve 30 with reference to “FIG. 3 to FIG. 5 that are cross-sectional views of the vicinity of a tip of the fuel injection valve 30”. As described above, when the solenoid 34 is in the unenergized state, the needle valve 32 is urged to the injection hole 31a side by the spring 33. As a result, for example, as shown in FIG. 3, a needle seat wall surface 32c of the needle valve 32 abuts against (is seated on) a nozzle seat wall surface 31c that is an inner wall surface at the tip of the nozzle main body section 31. That is, the nozzle seat wall surface 31c corresponds to the valve seat. In this way, a sack S that communicates with the injection hole 31a is blocked from the above-described fuel passage FP. Thus, the fuel is not injected from the injection hole 31a. The needle lift amount in this state is “zero”.

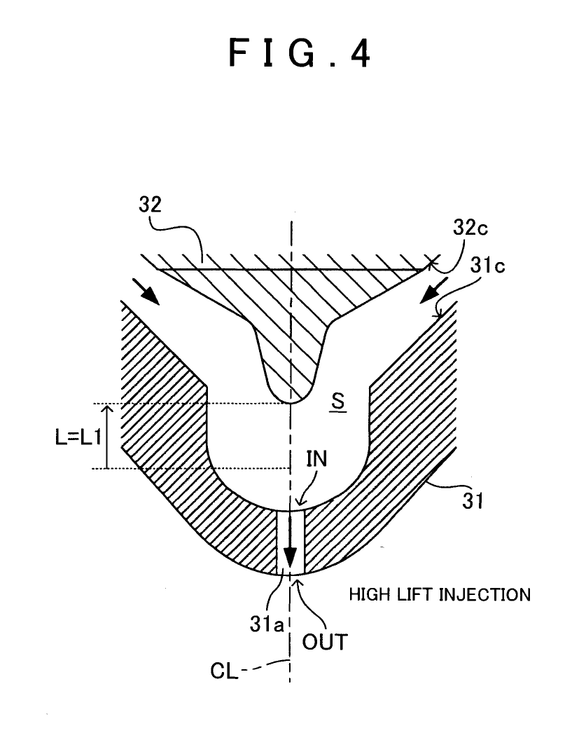

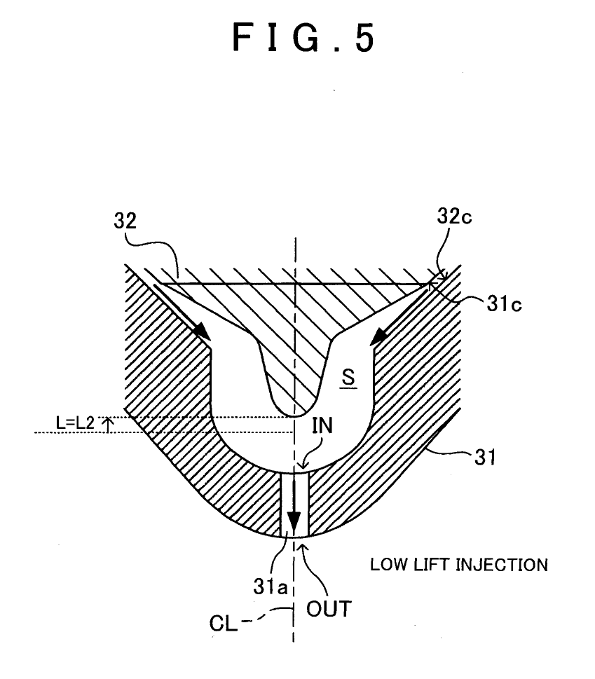

On the contrary, when the solenoid 34 is brought into the energized state, the needle valve 32 moves to the fuel intake hole 31b side. More specifically, when the solenoid 34 is brought into the energized state, for example, as shown in FIG. 4, a needle lift amount L becomes a value L1 that is larger than “zero” (a maximum lift amount Lmax in this example). Alternatively, as shown in FIG. 5, the needle lift amount L becomes a value L2 that is larger than “zero” (however, the value L2 is smaller than the value L1). In other words, the arrival lift amount in the example shown in FIG. 4 is L1, and the arrival lift amount in the example shown in FIG. 5 is L2. As a result, the sack S, which communicates with the injection hole 31a, communicates with the above-described fuel passage FP. Thus, the fuel flows from the fuel passage FP into the sack S and is then injected to the outside through the injection hole 31a.

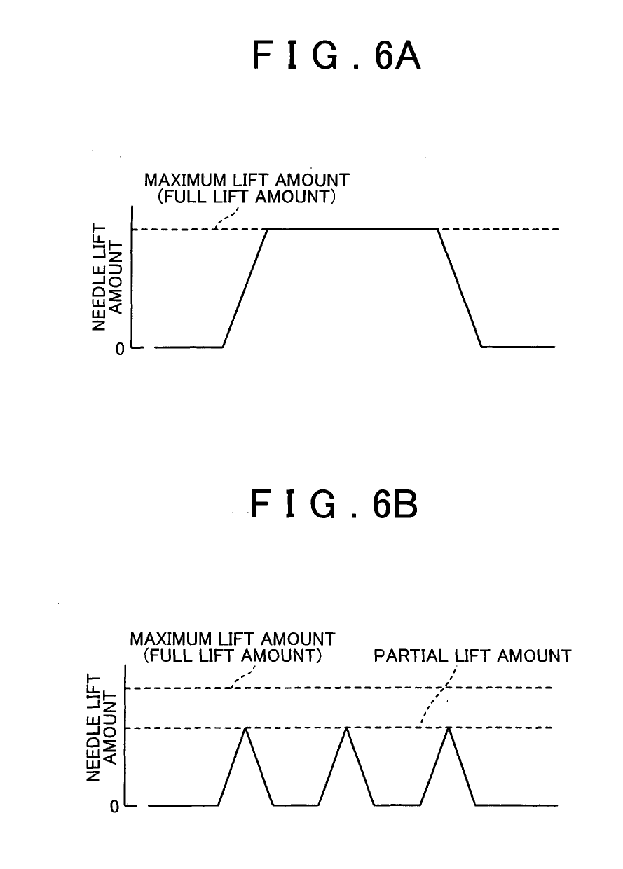

(A difference between high lift injection and low lift injection) In the fuel injection valve 30, a maximum value of the needle lift amount (that is, a lift amount of the needle valve 32) is controlled to be variable either by controlling a period for energizing the solenoid 34 of the fuel injection valve 30 or by adjusting a supply current amount to the solenoid 34. In other words, the ECU 50 as the control section can increase/reduce the arrival lift amount (a maximum value of the displacement) of the valve body (the needle valve 32) of the fuel injection valve 30 when the fuel is injected into the combustion chamber 20. Injection for which the needle valve 32 is lifted for a maximum lift amount (that is, a full lift amount) Lmax is referred to as full lift injection. Meanwhile, injection for which the needle valve 32 is lifted within a range of a partial lift amount that is smaller than the full lift amount is referred to as partial lift injection. FIG. 6A shows a temporal change of the needle lift amount in the single full lift injection. FIG. 6B shows a temporal change of the needle lift amount in the partial lift injections of three times.

As described above, in the case where the fuel injection valve 30 injects the fuel, the fuel flows into the sack S from the fuel passage FP in conjunction with a change of the needle lift amount L from “zero” to the arrival lift amount (L1 or L2). Then, the fuel is injected to the outside through the injection hole 31a. Thereafter, the needle lift amount L returns from the arrival lift amount to “zero”. In this way, the sack S is blocked from the fuel passage FP, and the fuel injection is terminated. At this time, a gap between the needle seat wall surface 32c and the nozzle seat wall surface 31c is wider in the case of the full lift injection than in the case of the partial lift injection. Thus, a flow rate of the fuel that flows from the fuel passage FP into the sack S is higher in the case of the full lift injection than in the case of the partial lift injection. In other words, pressure of the fuel that is injected to the outside through the injection hole 31a is higher in the case of the full lift injection than in the case of the partial lift injection. As a result, the momentum (the penetration force) of the fuel spray that is injected to the outside through the injection hole 31a is also larger in the case of the full lift injection than in the case of the partial lift injection.

<Fuel Injection Control According to First Mode> A description will be made on an operation in the first mode. In general, the fuel injection control apparatus according to the first mode executes feedback control on a fuel amount injected from the fuel injection valve 30 such that an air-fuel ratio (A/F) of the air-fuel mixture becomes a target air-fuel ratio. As described above, in the stratified charge combustion, a fuel consumption rate is improved by combustion of the lean air-fuel mixture in the entire cylinder. More specifically, the control apparatus executes control such that the air-fuel ratio (A/F) of the air-fuel mixture becomes the higher (leaner) target air-fuel ratio than the theoretical air-fuel ratio (14.7). In this feedback control, control is executed to cancel a deviation between air-fuel ratio information and the target air-fuel ratio that is set in advance. The air-fuel ratio information is obtained by the air-fuel ratio sensor that is disposed upstream of a catalyst in an exhaust passage. Since the details of the air-fuel ratio feedback control are well known to those skilled in the art, the detailed description will not be made in this specification.

Furthermore, the fuel injection control apparatus according to the first mode performs the split injection (may also be referred to as “multiple injection”), in which the fuel is divided and injected for plural times in a compression stroke of the engine 10 by the ECU 50 as the control section, so as to perform the stratified charge combustion. The split injection is injection in which ON and OFF of the fuel injection is continuously repeated by opening and closing the fuel injection valve for plural times in a relatively short period in one engine cycle.

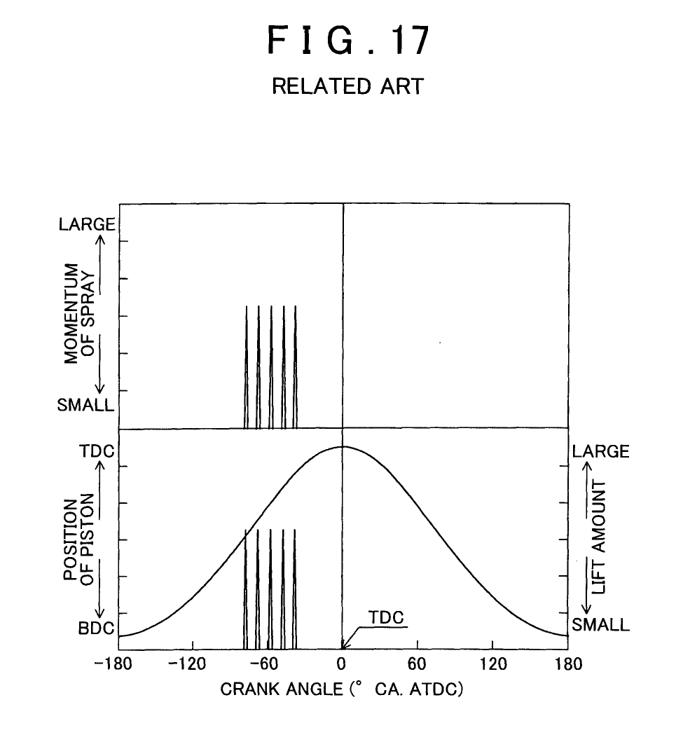

By the way, in the case where the fuel injection control apparatus according to the conventional art performs the split injection in the compression stroke, as shown in FIG. 17, in general, a total fuel amount that is injected by the split injection is equally divided for injections of plural times. In this way, a fuel injection amount for a single injection in the split injection is determined. In a lower side of FIG. 17, a graph (a curve) for showing a relationship between a crank angle (a horizontal axis) and a position of the piston (a vertical axis on the left side) and a graph (five pulse-like waveforms) for showing a relationship between the crank angle (the horizontal axis) and the lift amount of the fuel injection valve (the vertical axis on the right side) in such a case are shown.

As indicated by the above curve, the position of the piston moves from compression bottom dead center (BDC) to the compression top dead center (TDC) in conjunction with an increase of the crank angle from −180° to 0°. In other words, the engine is in the compression stroke in a period in which the crank angle reaches 0° from −180°. Meanwhile, the position of the piston moves from the compression top dead center (TDC) to expansion bottom dead center (BDC) in conjunction with the increase of the crank angle from 0° to 180°. In other words, the engine is in an expansion stroke in a period in which the crank angle reaches 180° from 0°.

As indicated by the above five pulse-like waveforms, in this example, the total fuel amount that is injected by the split injection in the compression stroke of the engine is equally divided for the injection of five times, and is then injected. More specifically, the arrival lift amount of the fuel injection valve in all of the injections of five times, which constitute the split injection, is set to be the same. In an upper side of FIG. 17, a graph (the five pulse-like waveforms) for showing a relationship between the crank angle (the horizontal axis) and the momentum of the spray (the vertical axis) in such a case is shown. As indicated by the above five pulse-like waveforms, in this example, the momenta (the penetration forces) of the fuel spray injected from the fuel injection valve in the injections of five times, which constitute the split injection, are all the same.

By the way, the piston is located away from the fuel injection valve at a time point when a first injection in the split injection (that is, a first injection in the compression stroke) is performed. For this reason, in the case where the momentum (the penetration force) of the fuel spray, which is injected from the fuel injection valve, is large, as described above, it may be difficult for the fuel spray to enter the piston cavity and be deflected in the direction toward the ignition plug.

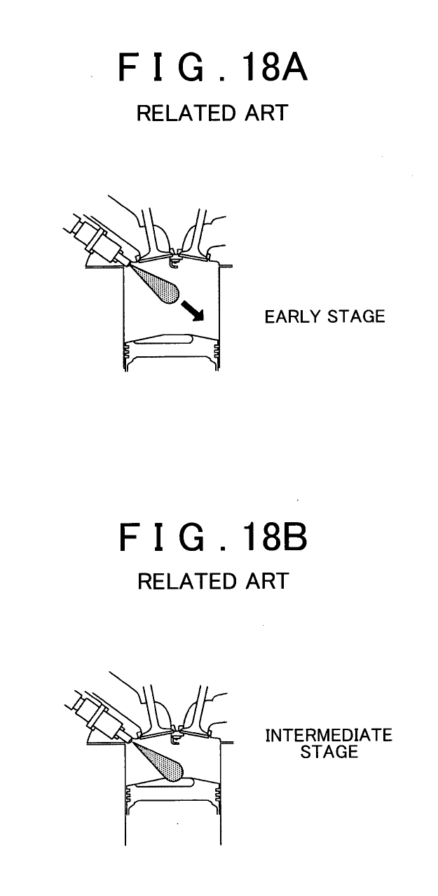

More specifically, for example, in the case where the fuel injection with the large momentum (the penetration force) is performed in the internal combustion engine of the side injection type, as shown in FIG. 18B, the fuel spray, which is injected from the fuel injection valve, is appropriately guided into the piston cavity, deflected in the direction toward the ignition plug by the inner wall of the piston cavity, and subject to the stratified charge combustion at an intermediate stage of the injection in the compression stroke. On the contrary, at an early stage of the injection in the compression stroke, the distance between the fuel injection valve and the piston is long. Thus, the fuel spray may move within the combustion chamber and separate from the piston cavity before the crown surface of the piston is elevated and hits the fuel spray. As a result, the fuel spray may not enter the piston cavity. In the example shown in FIG. 18A, the fuel spray immediately after the injection is located above the piston cavity. However, by the time the piston is elevated and the crown surface thereof hits the fuel spray, as indicated by a black arrow, the fuel spray bypasses the piston cavity and reaches the vicinity of the cylinder inner wall on a right side. That is, the fuel spray is not appropriately guided into the piston cavity. As a result, a fuel amount for producing the air-fuel mixture, which is deflected in the direction toward the ignition plug by the piston cavity and thus has the favorable combustibility, in the vicinity of the ignition plug is reduced. For this reason, the stratified charge combustion may become unstable.

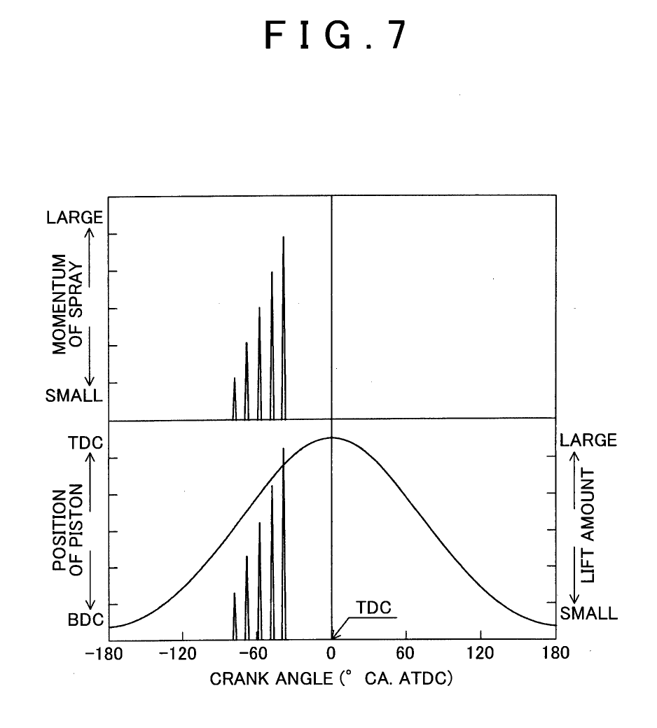

Meanwhile, in the fuel injection control apparatus according to the first mode, the ECU 50 performs the split injection in which the fuel is injected for five times in a first period of the compression stroke of the engine 10 (a crank angle range from approximately −80° to approximately −40° in FIG. 7). At this time, the arrival lift amount in the each injection is set as a larger value as the crank angle of the engine 10 approaches the compression top dead center. Similar to FIG. 17, in a lower side of FIG. 7, a graph (a curve) for showing a relationship between the crank angle (the horizontal axis) and the position of the piston (the vertical axis on the left side) and a graph (the five pulse-like waveforms) for showing a relationship between the crank angle (the horizontal axis) and the lift amount of the fuel injection valve (the vertical axis on the right side) in such a case are shown.

In the upper side of FIG. 7, a graph (the five pulse-like waveforms) for showing a relationship between the crank angle (the horizontal axis) and the momentum of the spray (the vertical axis) in such a case is shown. As indicated by the above five pulse-like waveforms, in this example, the momentum (the penetration force) of the fuel spray injected from the fuel injection valve in the injections of five times, which constitute the split injection, is increased as the crank angle of the engine 10 approaches the compression top dead center.

According to the above, in the fuel injection control apparatus according to the first mode, the momentum (the penetration force) of the fuel spray, which is injected from the fuel injection valve, is small at the early stage of the injection in the compression stroke, at which the distance between the fuel injection valve and the piston is long. As a result, the combustible air-fuel mixture with the favorable combustibility can also be produced in the vicinity of the ignition plug at the early stage of the injection in the compression stroke. Thus, the stable stratified charge combustion can be secured.

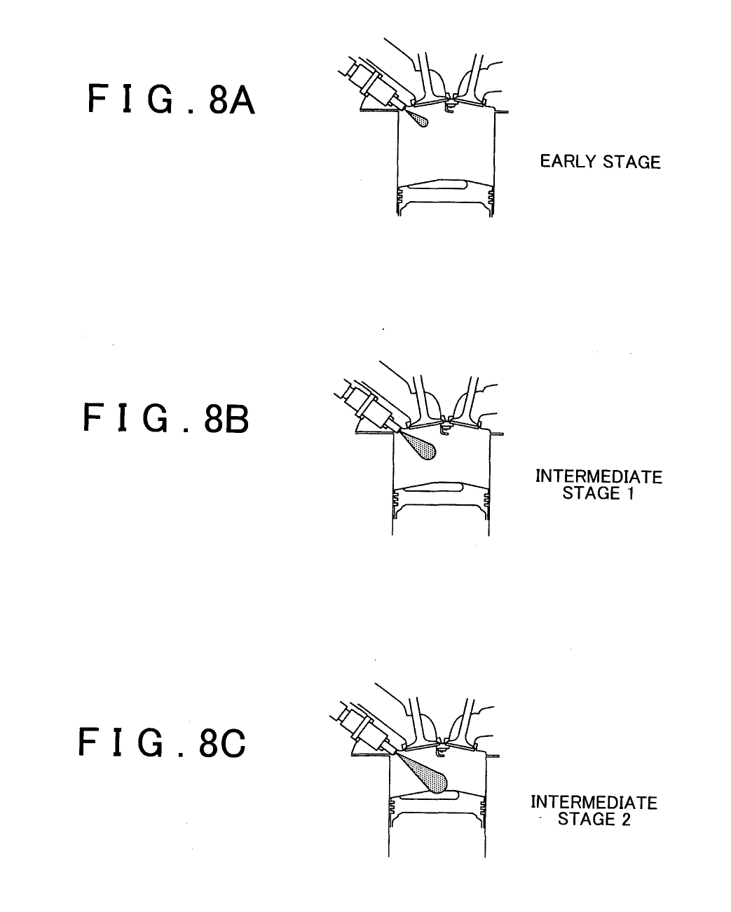

More specifically, for example, in the case where the split injection, in which the fuel is divided and injected for the plural times, is performed in the compression stroke of the internal combustion engine of the side injection type, as shown in FIG. 8A, the fuel spray with the small momentum (the small penetration force) is injected at the early stage of the injection in the compression stroke, at which the position of the piston is low. As a result, as in the fuel injection control apparatus according to the conventional art shown in FIG. 18A, it is possible to avoid such a problem that the fuel spray bypasses the piston cavity and reaches the vicinity of a right end of the combustion chamber. The thus-injected fuel spray is caught in the piston cavity that is elevated later as the crank angle approaches the compression top dead center, and thus produces the combustible air-fuel mixture with the favorable combustibility in the vicinity of the ignition plug. Meanwhile, at the intermediate stage onward of the injection in the compression stroke, as shown in FIG. 8B and FIG. 8C, the momentum (the penetration force) of the fuel spray, which is injected from the fuel injection valve, is gradually increased as the piston approaches the fuel injection valve. The thus-injected fuel spray is appropriately guided into the piston cavity, deflected in the direction toward the ignition plug by the inner wall of the piston cavity, and subject to the stratified charge combustion. Noted that details on the number of times of the split injection, the fuel injection amount in the each injection, and the like will be described below.

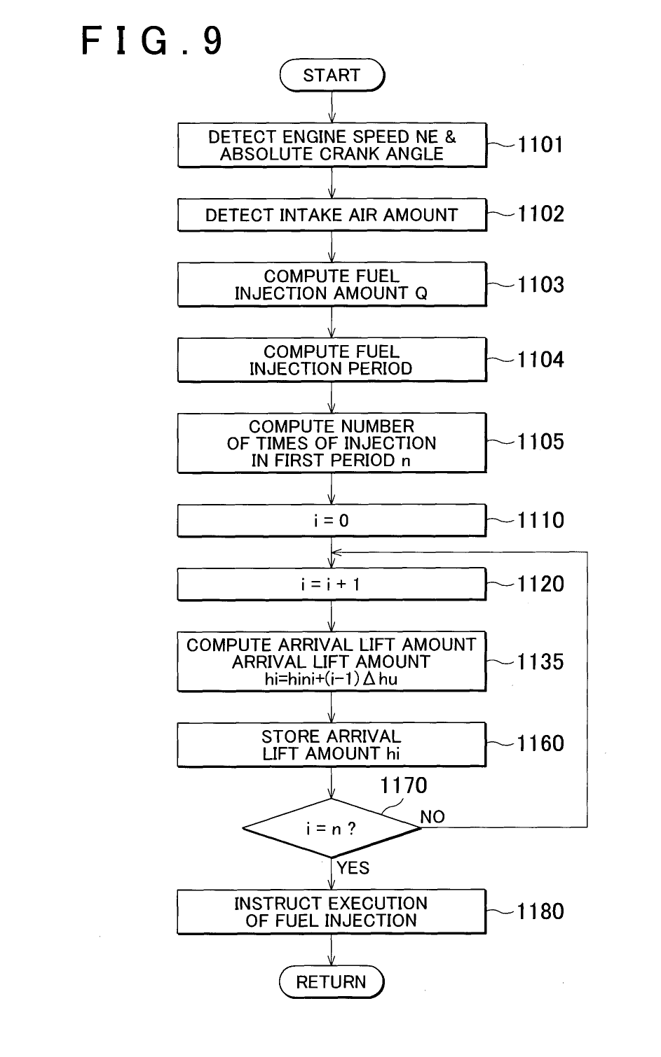

(A fuel injection control flow in the first mode) A description will be made on the operation in the first mode with reference to a flowchart in FIG. 9. The CPU of the ECU 50 executes routines shown in the flowchart in FIG. 9 at a specified crank angle. Thus, a process in FIG. 9 is initiated at appropriate timing. First, in step 1101, the ECU 50 detects the engine speed NE and the absolute crank angle on the basis of the signals from the crank position sensor 51 and the cam position sensor (not shown). Then, in step 1102, the ECU 50 detects an intake air amount on the basis of the signal from the airflow meter 52. Then, in step 1103, the ECU 50 computes a fuel injection amount (a fuel injection amount requested per cycle) Q on the basis of the engine speed NE, the intake air amount, and the like. As described above, in the stratified charge combustion, the lean air-fuel mixture can be combusted in the entire cylinder. Thus, the ECU 50 computes the fuel injection amount Q with which the air-fuel ratio (A/F) of the air-fuel mixture becomes the target air-fuel ratio that is higher (leaner) than the theoretical air-fuel ratio.

Next, in step 1104, the ECU 50 computes fuel injection period (a crank angle range in which the fuel injection is performed) on the basis of the engine speed NE, the fuel injection amount Q, and the like, for example. Noted that, as described above, if the fuel injection amount Q is increased, a period that is required for the fuel to become the combustible air-fuel mixture by drawing the heat from the wall surface of the combustion chamber is extended. Thus, the fuel injection period is determined such that this period can be secured. From the thus-determined fuel injection period (the crank angle range) and the engine speed NE, duration of the period in which the fuel injection is allowed to be executed is identified. Noted that, in this example, the split injection is performed throughout the fuel injection period that is determined as described above. While the split injection is performed, the arrival lift amount is increased as the crank angle of the engine 10 approaches the compression top dead center. In other words, in this example, the fuel injection period corresponds to the first period.

Next, in step 1105, the ECU 50 computes the number of times of the split injection in the first period of the compression stroke (the number of times of injection in the first period) n on the basis of the thus-identified duration of the fuel injection period, an opening/closing speed of the fuel injection valve 30 (a response speed to an instruction signal from the ECU 50), a fuel amount that can be injected from the fuel injection valve 30 by the single injection, and the like.

Here, in step 1110, the ECU 50 sets a counter i to 0 (zero). In next step 1120, the ECU 50 counts up the counter i by one. Furthermore, in next step 1135, the ECU 50 computes the arrival lift amount in the fuel injection of i time. In this example, the arrival lift amount in the fuel injection of the first time is set as hini. Thereafter, the arrival lift amount is increased by the same amount (Δhu) in the fuel injections of the second time onward. In this case, an arrival lift amount hi in the injection of i time is expressed by the following equation (1).

[Equation 1]

hi=hini+(i−1)×Δhu (1)

Noted that the arrival lift amount hini in the fuel injection of the first time is set as an arrival lift amount in such a degree that the fuel spray of the initial injection in the first period, which is injected from the fuel injection valve 30, does not bypass the piston cavity 60 and thus does not reach the vicinity of the cylinder inner wall on the right side, for example. The specific increased amount Δhu of the arrival lift amount in the fuel injections of the second time onward is set on the basis of control accuracy of the lift amount of the fuel injection valve 30, the crank angle at each injection timing (a distance between the fuel injection valve 30 and the piston 17), the engine speed NE, the fuel injection amount Q, and the like, for example. Together with the injection execution timing, the thus-set arrival lift amount hi (i=1, 2, 3 . . . ) in the fuel injection of i time is stored as a set value that is used when the next fuel injection is performed, and is stored in a data storage device (the RAM or the like, for example) provided in the ECU 50, for example, in next step 1160.

In next step 1170, the ECU 50 determines whether the arrival lift amount hi is set for all of the fuel injections in the first period, the fuel injection being divided for n times. More specifically, the ECU 50 determines whether i is equal to n. If it is determined that i is equal to n (step 1170: Yes), the ECU 50 proceeds to next step 1180. At this time, the arrival lift amounts hi for all of the split injections of n times are already set and stored in the data storage device. In step 1180, the execution of the fuel injection is instructed on the basis of the fuel injection period (the first period) that is computed in step 1104, the number of times of injection in the first period n that is computed in step 1105, and the arrival lift amounts hi that are computed in step 1135 and stored in the data storage device in step 1160.

On the contrary, if it is determined that i is not equal to n in step 1170 (step 1170: No), the ECU 50 returns to step 1120. Then, the flow from the step 1120 to step 1170 is repeated. In this way, until the arrival lift amounts hi for all of the split injections of n times are set, the flow from step 1120 to step 1170 is repeated.

By the way, in the case where there is no opportunity to inject the fuel other than the split injection in the above first period of the one cycle of the engine 10, needless to say, the number of times of injection in the first period n and the arrival lift amount hi in the each injection are set such that the fuel injection amount Q, which is requested per cycle, is equal to the total fuel injection amount in the entire split injection described above. In other words, the number of times of injection in the first period n and the arrival lift amount hi in the each injection are set to satisfy the following equation (2).

$$\begin{matrix}[ Equation 2 ] & \\ {\sum }_{i = 1}^{n} qi = {\sum }_{i = 1}^{n} f ( hi ) = Q & ( 2 )\end{matrix}$$

In the above equation, qi represents the fuel injection amount in each of the injections that constitute the split injection. For example, in the case where the split injection as shown in FIG. 6B is performed, the fuel injection amount qi in the each injection is increased as the arrival lift amount hi in the each injection is increased. Just as described, the fuel injection amount qi in the each injection has a positive correlation with the arrival lift amount hi in the each injection. In the above equation, the fuel injection amount qi in the each injection is expressed by a function f that at least has the arrival lift amount hi in the each injection as a parameter.

Noted that the description has been made on the above case where there is no opportunity to inject the fuel other than the split injection in the first period of the one cycle of the engine 10. However, for example, when it is difficult to inject the fuel injection amount Q, which is requested per cycle, only by the split injection performed in the first period, the fuel injection may further be performed before and/or after the first period.

Furthermore, execution orders of the routines that constitute the fuel injection control flow represented by the above flowchart may be switched without causing any contradiction. Moreover, in the above description, the arrival lift amount is increased by the same amount (Δhu) for the fuel injections of the second time onward. However, the increased amount (Δhu) of the arrival lift amount for the fuel injections of the second time onward does not always have to be the same and thus may differ each time.

As described above, according to the fuel injection control apparatus according to the first mode, the arrival lift amount hi in each of the injections, which constitute the split injection performed in the first period, is set as the larger value as the crank angle of the engine 10 approaches the compression top dead center. Accordingly, the arrival lift amount is set as a small value in the injection at the early stage of the injection in the compression stroke, at which the distance between the fuel injection valve and the piston is long. In other words, the momentum (the penetration force) of the fuel spray, which is injected from the fuel injection valve, is small in the injection at the early stage of the injection in the compression stroke. As a result, it is possible to avoid a reduction of the fuel amount that is injected at the early stage of the injection in the compression stroke and subject to the stratified charge combustion. Furthermore, the fuel spray with the appropriate momentum (the penetration force) is appropriately guided into the piston cavity at the intermediate and late stages of the injection in the compression stroke. The fuel spray is deflected in the direction toward the ignition plug and subject to the stratified charge combustion. As a result, the combustible air-fuel mixture with the favorable combustibility can be produced in the vicinity of the ignition plug. Thus, the stable stratified charge combustion can be secured.

### Second Embodiment

By the way, as described above, for example, in the case where it is difficult to inject the fuel injection amount Q, which is requested per cycle, only by the split injection performed in the first period, the fuel may be injected prior to the above first period. The arrival lift amount in this injection can be set as a larger value or a smaller value than the arrival lift amount for performing the initial injection in the first period. Alternatively, the arrival lift amount in this injection can be set as the same value as the arrival lift amount for performing the initial injection in the first period.

Here, in a period prior to the first period of the compression stroke of the engine, the distance between the fuel injection valve and the piston is longer than that when the initial injection is performed in the first period. Thus, in order to avoid such a situation that the fuel spray does not enter the piston cavity as described above, the arrival lift amount in the injection that is performed prior to the first period of the compression stroke of the engine is preferably set as a smaller value than the arrival lift amount for performing the initial injection in the first period.

In view of the above, the control section according to a second embodiment of the invention (hereinafter may be referred to as a “second mode”) causes the fuel injection valve to inject the fuel at least once in a second period prior to the first period, and also sets the arrival lift amount for the each injection in the same second period as a smaller value than the arrival lift amount for the initial injection in the first period.

Accordingly, as described above, the fuel that is injected in the second period prior to the first period has the substantially small momentum. Thus, at least some (desirably more) of the fuel is likely to remain in the vicinity of the fuel injection valve (an upper section of the combustion chamber). For this reason, the fuel injected in the second period is likely to be caught in the piston cavity when the piston is elevated later, and thus is likely to contribute to production of the combustible air-fuel mixture with the favorable combustibility. As a result, a larger fuel amount can be used to produce the combustible air-fuel mixture.

In this case, if there is no opportunity to inject the fuel other than the split injection in the first period and the second period, the number of times of injection in the first period n, the number of times of injection in the second period, and the arrival lift amount hi in the each injection are set such that the fuel injection amount Q, which is requested per cycle, becomes equal to the total fuel injection amount in the entire split injection in the first period and the second period.

### Third Embodiment

By the way, as described above, for example, when it is difficult to inject the fuel injection amount Q, which is requested per cycle, only by the split injection performed in the first period, the fuel may be injected after the above first period. The arrival lift amount in this injection can be set as a larger value or a smaller value than the arrival lift amount for performing the final injection in the first period. Alternatively, the arrival lift amount in this injection can be set as the same value as the arrival lift amount for performing the final injection in the first period.

Here, the piston approaches the fuel injection valve as the crank angle approaches the compression top dead center in the compression stroke of the engine. Accordingly, the distance between the piston and the fuel injection valve is reduced as time is closer to a final stage of the compression stroke. Regardless of this fact, if the momentum (the penetration force) of the fuel spray that is injected from the fuel injection valve keeps being increased as the crank angle approaches the compression top dead center, the momentum (the penetration force) of the fuel spray is excessively increased with respect to the distance between the piston and the fuel injection valve. This may produce a fuel wet state. With generation of the fuel wet state, smoke, PM, or the like may be produced, for example.

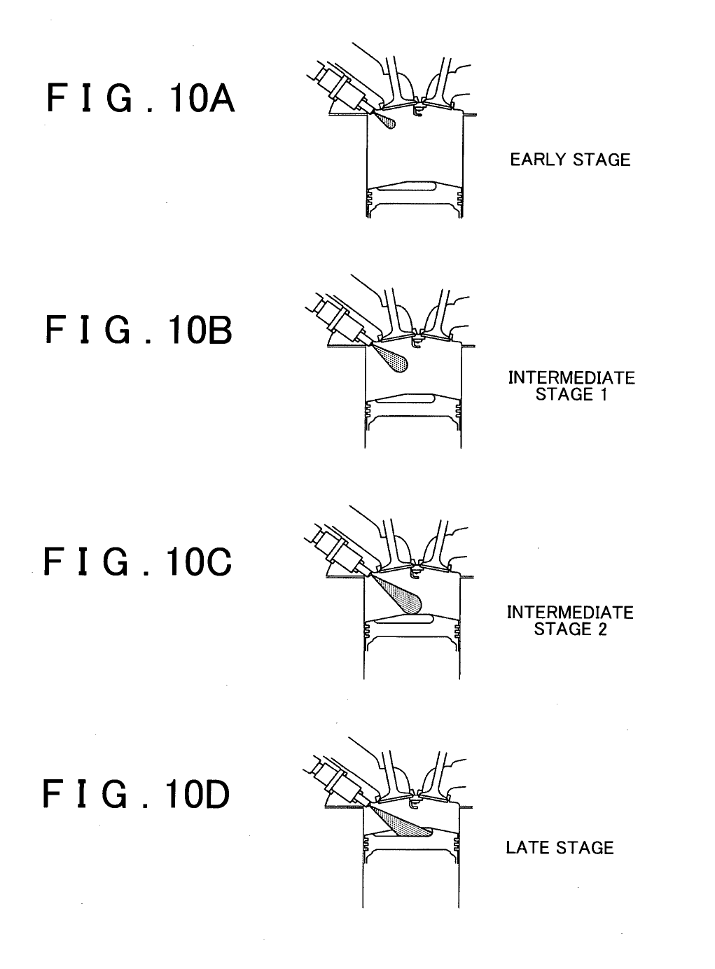

Regarding the above, a description will herein be made with reference to FIG. 10A to FIG. 10D. As described above, FIG. 10A to FIG. 10D are schematic views of statuses of the fuel spray and the position of the piston at the early stage, an intermediate stage 1, an intermediate stage 2, and a late stage in the case where the momentum (the penetration force) of the fuel spray keeps being increased in the compression stroke. As the fuel injection control apparatus according to the first mode has been described with reference to FIG. 8A to FIG. 8C, the appropriate fuel spray is produced with respect to the position of the piston from the early stage (FIG. 10A) to the intermediate stage 2 (FIG. 10C). However, if the momentum (the penetration force) of the fuel spray is further increased at the late stage (FIG. 10D), at which the distance between the piston and the fuel injection valve is further reduced, a wet amount is increased.

Thus, in order to avoid an increase in the wet amount at the late stage of the compression stroke, it is desirable not to increase the arrival lift amount of the fuel injection valve at the late stage of the compression stroke, at which the distance between the piston and the fuel injection valve is extremely reduced. More specifically, the control section, which is provided in the fuel injection control apparatus according to the invention, desirably controls the fuel injection valve such that the arrival lift amount is maintained at a predetermined specified value after the first period of the compression stroke.

Accordingly, the control section according to a third embodiment of the invention (hereinafter may be referred to as a “third mode”) causes the fuel injection valve to inject the fuel at least once in a third period after the first period, and also maintains the arrival lift amount for the each injection in the same third period at the predetermined specified value.

The above “predetermined specified value” is a value that corresponds to an upper limit value of the arrival lift amount with which the fuel injection can be performed without increasing the wet amount in the third period after the first period of the compression stroke. In other words, the above “predetermined specified value” is a value that corresponds to a threshold at which the wet amount is increased if the arrival lift amount is set higher than the “predetermined specified value” in the fuel injection performed in the third period. For example, the above “predetermined specified value” can be determined in advance by an experiment or the like.

Strictly speaking, whether the fuel wet state is generated in each of the injections that constitute the split injection depends not only on the arrival lift amount of the fuel injection valve in each injection but also on the crank angle (the distance between the fuel injection valve and the piston), the engine speed NE, and the like at the each injection timing. Thus, the above “predetermined specified value” can be determined in advance by an experiment or the like, for example, in which the fuel is injected at various engine speeds NE, at various injection timing (crank angles), and in various arrival lift amounts.

In the fuel injection control apparatus according to the third mode, the arrival lift amount is maintained at the “predetermined specified value”, which is determined as described above in the third period after the first period. In this way, the momentum (the penetration force) of the fuel spray is avoided from excessively increased at the late stage of the injection in the compression stroke, at which the distance between the fuel injection valve and the piston is short. As a result, the increase in the wet amount is suppressed. Thus, a chance that a problem of the smoke, the PM, or the like, for example, arises is reduced.

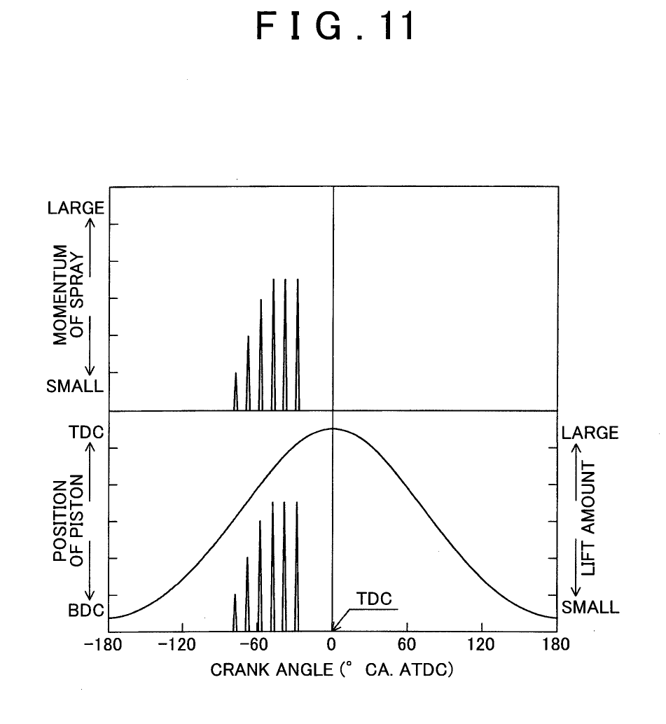

Noted that configurations of the internal combustion engine, the control section, and the fuel injection valve, and the like in the third mode are the same as those in the first mode. Thus, the overlapping description will not be made.

<Fuel Injection Control according to Third Mode> Here, an operation in the third mode will be described. In a lower side of FIG. 11, similar to FIG. 7, a graph (a curve) for showing a relationship between the crank angle (the horizontal axis) and the position of the piston (the vertical axis on the left side) and a graph (six pulse-like waveforms) for showing a relationship between the crank angle (the horizontal axis) and the lift amount of the fuel injection valve (the vertical axis on the right side) in such a case are shown. As shown in the lower side of FIG. 11, also in the fuel injection control apparatus according to the third mode, the ECU 50 performs the split injection in which the fuel is injected for four times in the first period of the compression stroke of the engine 10 (a crank angle range from approximately −80° to approximately −50° in FIG. 11). At this time, the arrival lift amount in the each injection is set as a larger value as the crank angle of the engine 10 approaches the compression top dead center.

As described above, the fuel injection control apparatus according to the third mode increases the arrival lift amount in the first to fourth injections that correspond to the injections in the first period. However, in the injections (the fifth injection onward) in the third period (a crank angle range from approximately −40° to approximately −30° in FIG. 11) after the first period, the fuel injection control apparatus maintains the arrival lift amount to be constant at the arrival lift amount in the fourth injection. In other words, in this example, the above-described “predetermined specified value” is the same value as “the arrival lift amount in the fourth injection” (that is, the arrival lift amount for the final injection in the first period).

In an upper side of FIG. 11, a graph (the six pulse-like waveforms) for showing a relationship between the crank angle (the horizontal axis) and the momentum of the spray (the vertical axis) in the case as described above is shown. As indicated by the above six pulse-like waveforms, in this example, the momentum (the penetration force) of the fuel spray is increased as the crank angle of the engine 10 approaches the compression top dead center in the first to fourth injections, which correspond to the injections in the first period, among the injections of six times that constitute the split injection. Furthermore, the momentum (the penetration force) of the fuel spray in the injections (the fifth injection onward) in the third period after the first period is maintained to be constant at the momentum (the penetration force) in the fourth injection.

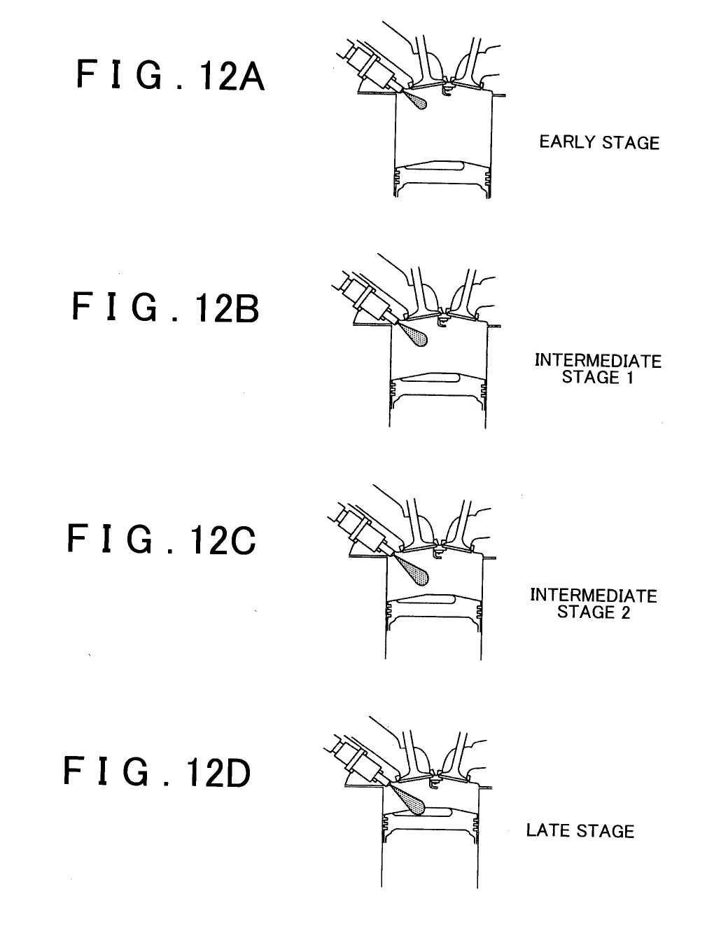

As described above, in the fuel injection control apparatus according to the third mode, the momentum (the penetration force) of the fuel spray that is injected from the fuel injection valve is small at the early stage of the injection in the compression stroke, at which the distance between the fuel injection valve and the piston is long. As a result, for example, in the case where the split injection is performed in the internal combustion engine of the side injection type, the fuel spray with the small momentum (the penetration force) as shown in FIG. 12A is injected at the early stage of the injection in the compression stroke, at which the position of the piston is low. Accordingly, as in the fuel injection control apparatus according to the conventional art shown in FIG. 18A, it is possible to avoid such a problem that the fuel spray bypasses the piston cavity and reaches the vicinity of the right end of the combustion chamber. The thus-injected fuel spray has the small momentum (the penetration force), is caught in the piston cavity that is elevated later as the crank angle approaches the compression top dead center, and thus produces the combustible air-fuel mixture with the favorable combustibility in the vicinity of the ignition plug.

Next, at the intermediate stage (the intermediate stage 1 and the intermediate stage 2) of the injection in the compression stroke, as indicated by FIG. 12B and FIG. 12C, the momentum (the penetration force) of the fuel spray that is injected from the fuel injection valve is gradually increased as the piston approaches the fuel injection valve. The thus-injected fuel spray is appropriately guided into the piston cavity, deflected in the direction toward the ignition plug by the inner wall of the piston cavity, and subject to the stratified charge combustion.

Furthermore, at the late stage of the injection in the compression stroke, as indicated by FIG. 12D, the momentum (the penetration force) of the fuel spray that is injected from the fuel injection valve is not increased even when the piston further approaches the fuel injection valve. As a result, the increase in the wet amount as shown in FIG. 10D is suppressed. The thus-injected fuel spray is appropriately guided into the piston cavity, deflected in the direction toward the ignition plug by the inner wall of the piston cavity, and subject to the stratified charge combustion.

As described above, the fuel injection control apparatus according to the third mode produces the combustible air-fuel mixture with the favorable combustibility in the vicinity of the ignition plug also at the early stage of the injection in the compression stroke and suppresses the increase in the wet amount at the late stage of the injection in the compression stroke. Thus, the stable stratified charge combustion can be secured, and the problem of the smoke, the PM, or the like, for example can be avoided.

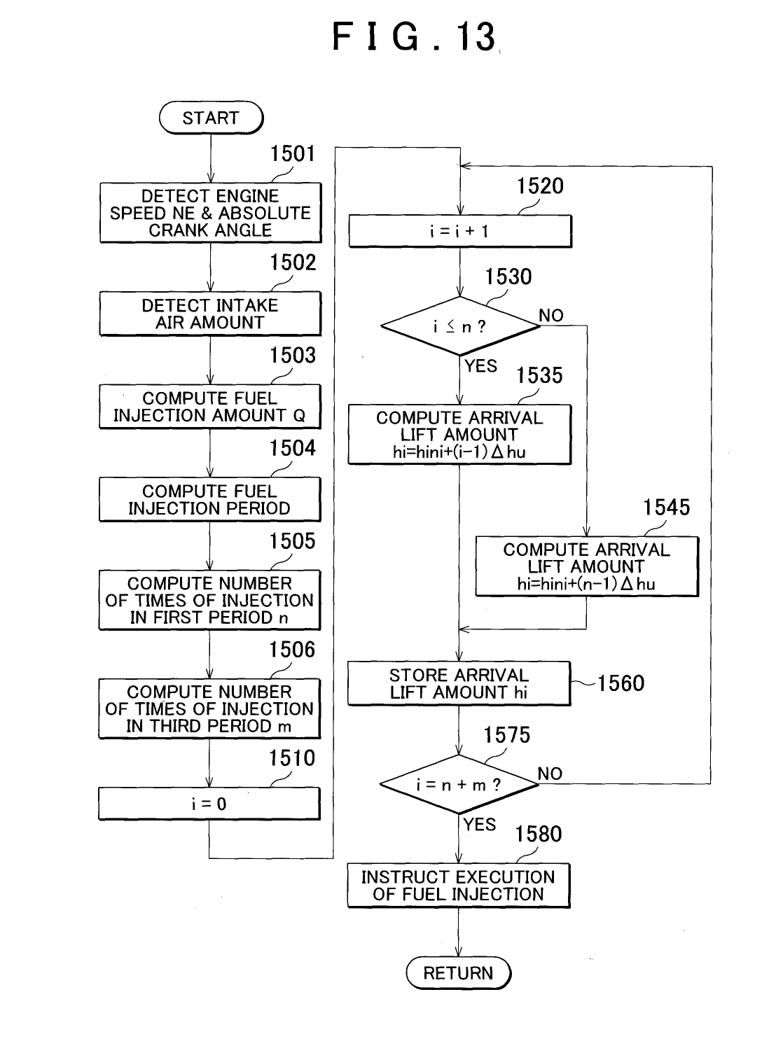

(Fuel injection control flow in the third mode) A description will be made on the operation in the third mode with reference to a flowchart in FIG. 13. The CPU in the ECU 50 executes routines shown in the flowchart in FIG. 13 at a specified crank angle. Noted that a fuel injection control flow in the third mode shown in the flowchart in FIG. 13 differs from the fuel injection control flow in the first mode shown in the flowchart in FIG. 9 only in following three points.

The first point is that, in step 1506, the number of times of split injection in the third period (the number of times of injection in the third period) m after the first period is computed. The second point is that it is determined in step 1530 whether the injection of i time in the compression stroke corresponds to the “injection of n times in the first period” and, if the injection of i time does not correspond to the injection of n times in the first period, the arrival lift amount is maintained to be constant in step 1545.

The third point is that the ECU 50 determines in step 1575 whether the arrival lift amount hi is set for all of the fuel injections (n+m times) that are performed in the first period and the third period. Noted that lower two digits of the number that is assigned to each of the steps corresponds to the content of the routine that is executed in the step. That is, in FIG. 13 and FIG. 9, the same routine is executed in the steps to which the numbers with the same lower two digits are assigned.

Accordingly, similar to the flowchart in FIG. 9, also in the flowchart in FIG. 13, the detection of the engine speed NE, the detection of the intake air amount, the computation of the fuel injection amount Q, the computation of the fuel injection period, and the computation of the number of times of injection in the first period n are executed in steps 1501 to 1505. Next, in step 1506, the number of times of injection in the third period m is computed. As described above, the “number of times of injection in the third period m” is the number of times of the split injection in the “third period” after the first period. Noted that, in this example, the split injection is performed for the entire fuel injection period that is determined as described above. In the split injection, the arrival lift amount in the injections of n times in the first period is increased as the crank angle of the engine 10 approaches the compression top dead center. In addition, the arrival lift amount in the injection of m times in the third period is maintained to be constant regardless of the crank angle of the engine 10. In other words, in this example, the arrival lift amount matches a total of the first period and the third period.

Next, similar to the flowchart in FIG. 9, also in the flowchart in FIG. 13, the counter i is set to 0 (zero) in step 1510, and the counter i is counted up in next step 1520. Then, it is determined in step 1530 whether the injection of i time in the compression stroke corresponds to the “injection of n times in the first period”. If it is determined in step 1530 that the injection of i time corresponds to the “injection of n times in the first period” (step 1530: Yes), the arrival lift amount in the fuel injection of i time is computed in next step 1535. At this time, the arrival lift amount in the fuel injection of the first time is set as hini. Thereafter, the arrival lift amount is increased by the same amount (Δhu) in the fuel injections of the second time to n time. In this case, the arrival lift amount hi in the fuel injection of i time is expressed by the above-described equation (1).

The arrival lift amount hini in the fuel injection of the first time and the increased amount Δhu of the arrival lift amount in the fuel injections from the second time to n time are set as described above. The arrival lift amounts hi (i=1, 2, 3 . . . , n) in the fuel injections from the first time to n time, which are set just as described, are stored as set values that are used when the next fuel injection is performed, and are stored in the data storage device (the RAM or the like, for example) provided in the ECU 50, for example, in next step 1560.

On the contrary, if it is determined in step 1530 that the injection of i time does not correspond to the “injection of n times in the first period” (step 1530: No), the arrival lift amount in the fuel injection of i time (n+1 time onward) is computed in next step 1545. In this example, the arrival lift amount in the fuel injections of n+1 time onward are maintained to be constant at the arrival lift amount in the fuel injection of n time. In this case, the arrival lift amount hi in the fuel injection of i time is expressed by the following equation (3).

[Equation 3]

hi=hini+(n−1)×Δhu (3)

As described above, the arrival lift amounts hi in the fuel injections of n+1 time onward are set to be the same value as the arrival lift amount hi in the fuel injection of n time. The arrival lift amounts hi (i=n+1, n+2 . . . , n+m) in the fuel injections of n+1 time onward, which are set just as described, are stored as set values that are used when the next fuel injection is performed, and are stored in the data storage device (the RAM or the like, for example) provided in the ECU 50, for example, in next step 1560.

In next step 1575, the ECU 50 determines whether the arrival lift amount hi is set for all of the fuel injections of n+m times that are performed in the first period and the third period. More specifically, the ECU 50 determines whether i is equal to n+m. If it is determined that i is equal to n+m (step 1575: Yes), the ECU 50 proceeds to next step 1580. At this time, the arrival lift amounts hi for all of the split injections of n+m times are already set and stored in the data storage device. In step 1580, execution of the fuel injection is instructed on the basis of the fuel injection period (the first period and the third period) that is computed in step 1504, the number of times of injection in the first period n that is computed in step 1505, the number of times of injection in the third period m that is computed in step 1506, and the arrival lift amounts hi that are computed in step 1535 and step 1545 and stored in the data storage device in step 1560.

On the contrary, if it is determined in step 1575 that i is not equal to n+m (step 1575: No), the ECU 50 returns to step 1520. Then, the flow from step 1520 to step 1575 is repeated. In this way, until the arrival lift amounts hi for all of the split injections of n+m times are set, the flow from step 1520 to step 1575 is repeated.

By the way, in the case where there is no opportunity to inject the fuel other than the split injection in the above first period and third period in the one cycle of the engine 10, needless to say, the number of times of injection in the first period n, the number of times of injection in the third period m, and the arrival lift amount hi in the each injection are set such that the fuel injection amount Q, which is requested per cycle, is equal to the total fuel injection amount in the entire split injection described above. In other words, the number of times of injection in the first period n, the number of times of injection in the third period m, and the arrival lift amount hi in the each injection are set to satisfy the following equation (2′). Noted that the definitions of qi and the function f in the equation (2′) are the same as those in the equation (2).

$$\begin{matrix}[ Equation {2}^{′} ] & \\ {\sum }_{i = 1}^{n + m} qi = {\sum }_{i = 1}^{n + m} f ( hi ) = Q & ( {2}^{′} )\end{matrix}$$

Noted that the above description has been made on the case where there is no opportunity to inject the fuel other than the split injection in the first period and the third period in the one cycle of the engine 10. However, for example, when it is difficult to inject the fuel injection amount Q, which is requested per cycle, only by the split injection performed in the first period and the third period, the fuel injection may further be performed in a period other than the first period and the third period. For example, as described above, the fuel injection may further be performed in the second period prior to the first period.

Furthermore, the execution orders of the routines that constitute the fuel injection control flow represented by the above flowchart may be switched without causing any contradiction. Moreover, in the above description, the arrival lift amount is increased by the same amount (Δhu) in the fuel injection from the second time to n time. However, the increased amount (Δhu) of the arrival lift amount in the fuel injection from the second time to n time does not always have to be the same and thus may differ each time.

In addition, in the above description, the routines in steps 1520, 1530, 1545, 1560, and 1575 are repeated for the fuel injections of n+1 time onward. However, in the above-described example, the arrival lift amount in the fuel injections of n+1 time onward is not increased and maintained to be the same as the arrival lift amount in the fuel injection of n time. In the case where the arrival lift amount in the fuel injections of n+1 time onward is maintained to be constant, just as described, once the number of times of injection reaches n+1 time, the arrival lift amounts in the injections of n+1 time onward may all be set as the arrival lift amount in the fuel injection of n time and may be stored in the data storage device. Then, the ECU 50 may proceed to step 1580 and instruct execution of the fuel injection.

As described above, according to the fuel injection control apparatus according to the third mode, the arrival lift amount hi in each of the injections that constitute the split injection performed in the first period is set as the larger value as the crank angle of the engine 10 approaches the compression top dead center. Thus, the arrival lift amount is set as the small value in the injection at the early stage of the injection in the compression stroke, at which the distance between the fuel injection valve and the piston is long. In other words, the momentum (the penetration force) of the fuel spray that is injected from the fuel injection valve is small in the injection at the early stage of the injection in the compression stroke. As a result, it is possible to avoid the reduction of the fuel amount that is injected at the early stage of the injection in the compression stroke and subject to the stratified charge combustion. Furthermore, the fuel spray with the appropriate momentum (the penetration force) is appropriately guided into the piston cavity at the intermediate stage of the injection in the compression stroke. The fuel spray is deflected in the direction toward the ignition plug and subject to the stratified charge combustion. Moreover, since the momentum (the penetration force) of the fuel spray is maintained to be constant at the late stage of the injection in the compression stroke, the increase in the wet amount is suppressed. As a result, the combustible air-fuel mixture with the favorable combustibility can be produced in the vicinity of the ignition plug. Thus, the stable stratified charge combustion can be secured, and the problem of the smoke, the PM, or the like can be avoided.

### Fourth Embodiment

By the way, in the above-described example, the arrival lift amount is increased in the split injection that is performed in the first period, and then the arrival lift amount is maintained to be constant in the split injection that is performed in the third period. That is, the momentum (the penetration force) of the fuel spray at the final stage of the injection in the compression stroke is relatively large. Meanwhile, since the distance between the fuel injection valve and the piston is extremely short at the final stage of the compression stroke, the above-described problem caused by the fuel wet state is highly likely to arise.

In order to avoid such a problem, it is considered, for example, to reduce a degree of increase of the arrival lift amount in the first period (at the early stage of the injection in the compression stroke), to set the arrival lift amount at the late stage of the injection in the compression stroke as a small value, and to reduce the momentum (the penetration force) of the fuel spray. Alternatively, it is considered, for example, to hasten termination time of the injection in the compression stroke by forbidding fuel injection at the crank angle in the vicinity of the compression top dead center or the like. However, the total fuel amount that can be injected in the injection in the compression stroke is reduced by adopting any of these measures. As a result, it may become more difficult to inject the fuel amount requested for the operation of the engine.

In view of the above, the inventor has reached an idea that the above problem can be solved by gradually reducing the arrival lift amount in the third period. More specifically, for the injection in the first period (at the early stage of the injection in the compression stroke), in which the distance between the fuel injection valve and the piston is long, the arrival lift amount of the fuel injection valve in the small value is gradually increased. For the injection in the third period (at the late stage of the injection in the compression stroke), in which the distance between the fuel injection valve and the piston is short, the arrival lift amount is gradually reduced. In this way, the momentum (the penetration force) of the fuel spray in the injection at the early stage of the injection in the compression stroke is reduced. Thereafter, the momentum (the penetration force) of the fuel spray is sufficiently increased in the subsequent injection. Then, the momentum (the penetration force) of the fuel spray can sufficiently be reduced at the late stage of the injection in the compression stroke.

Accordingly, the control section according to a fourth embodiment of the invention (hereinafter may be referred to as a “fourth mode”) causes the fuel injection valve to inject the fuel at least once in the third period after the first period, and also sets the arrival lift amount for the each injection in the same third period as a smaller value as the crank angle of the internal combustion engine approaches the compression top dead center.

Strictly speaking, as described above, whether the fuel wet state is generated in each of the injections that constitute the split injection depends not only on the arrival lift amount of the fuel injection valve in the each injection but also on the crank angle (the distance between the fuel injection valve and the piston), the engine speed NE, and the like at the each injection timing. For this reason, the specific arrival lift amount in the injection that is performed in the above third period can be determined in advance by an experiment or the like, for example, in which the fuel is injected at various engine speeds NE, at various injection timing (the crank angles), and in various arrival lift amounts.

According to the fuel injection control apparatus according to the fourth mode, the arrival lift amount of the fuel injection valve is gradually reduced in the period after the first period (that is, in the third period) as the crank angle of the internal combustion engine approaches the compression top dead center as described above. In other words, in the fourth mode, the momentum (the penetration force) of the fuel spray that is injected by the split injection performed at the late stage of the compression stroke is gradually reduced. Accordingly, the momentum (the penetration force) of the fuel spray is reliably avoided from excessively increased at the late stage of the injection in the compression stroke, at which the distance between the fuel injection valve and the piston is short. As a result, the “fuel wet” state in which the crown surface of the piston and/or the inner wall of the piston cavity gets wet by the fuel is further reliably suppressed. Thus, a chance that the problem of the smoke, the PM, or the like, for example, arises is further reliably reduced.

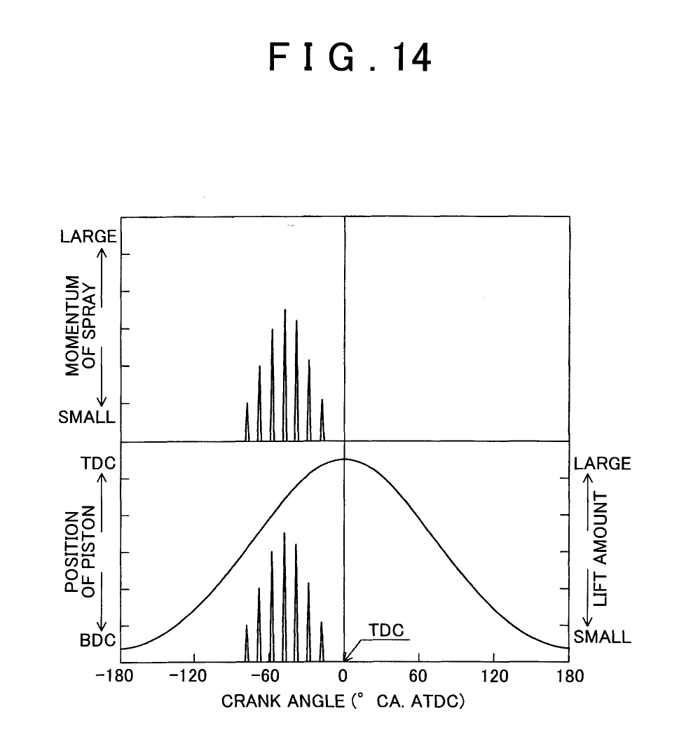

Noted that configurations of the internal combustion engine, the control section, and the fuel injection valve, and the like in the fourth mode are the same as those in the first mode to the third mode. Thus, the overlapping description will not be made.

<Fuel Injection Control According to Fourth Mode> Here, an operation in the fourth mode will be described. In a lower side of FIG. 14, similar to FIG. 11, a graph (a curve) for showing a relationship between the crank angle (the horizontal axis) and the position of the piston (the vertical axis on the left side) and a graph (seven pulse-like waveforms) for showing a relationship between the crank angle (the horizontal axis) and the lift amount of the fuel injection valve (the vertical axis on the right side) in such a case are shown. As shown in the lower side of FIG. 14, also in the fuel injection control apparatus according to the fourth mode, the ECU 50 performs the split injection in which the fuel is injected for four times in the first period (the crank angle range from approximately −80° to approximately −50° in FIG. 14) in the compression stroke of the engine 10. At this time, the arrival lift amount in the each injection is set as a larger value as the crank angle of the engine 10 approaches the compression top dead center.

As described above, the fuel injection control apparatus according to the fourth mode increases the arrival lift amount in the first to fourth injections that correspond to the injections in the first period. However, in the injections (the fifth injection onward) in the third period (the crank angle range from approximately −40° to approximately −20° in FIG. 14) after the first period, the fuel injection control apparatus gradually reduces the arrival lift amount in the fourth injection.

In an upper side of FIG. 14, a graph (seven pulse-like waveforms) for showing a relationship between the crank angle (the horizontal axis) and the momentum of the spray (the vertical axis) in the case as described above is shown. As indicated by the above seven pulse-like waveforms, in this example, the momentum (the penetration force) of the fuel spray is increased as the crank angle of the engine 10 approaches the compression top dead center in the first to fourth injections, which correspond to the injections in the first period, among the injections of seven times that constitute the split injection. Furthermore, the momentum (the penetration force) of the fuel spray in the injections (the fifth injection onward) in the third period after the first period is gradually reduced from the momentum (the penetration force) in the fourth injection.

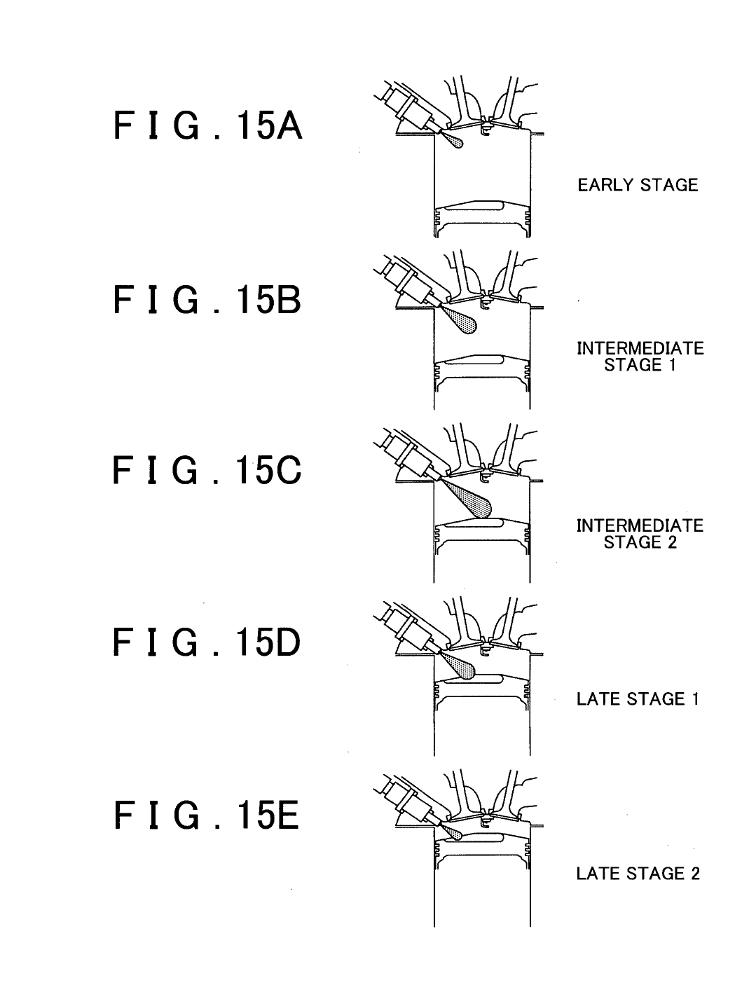

As described above, in the fuel injection control apparatus according to the fourth mode, the momentum (the penetration force) of the fuel spray that is injected from the fuel injection valve is small at the early stage of the injection in the compression stroke, at which the distance between the fuel injection valve and the piston is long. As a result, for example, in the case where the split injection is performed in the internal combustion engine of the side injection type, the fuel spray with the small momentum (the penetration force) as shown in FIG. 15A is injected at the early stage of the injection in the compression stroke, at which the position of the piston is low. Accordingly, as in the fuel injection control apparatus according to the conventional art shown in FIG. 18A, it is possible to avoid such a problem that the fuel spray bypasses the piston cavity and reaches the vicinity of the right end of the combustion chamber. The thus-injected fuel spray has the small momentum (the penetration force), is caught in the piston cavity that is elevated later as the crank angle approaches the compression top dead center, and thus produces the combustible air-fuel mixture with the favorable combustibility in the vicinity of the ignition plug.

Next, at the intermediate stage (the intermediate stage 1 and the intermediate stage 2) of the injection in the compression stroke, as indicated by FIG. 15B and FIG. 15C, the momentum (the penetration force) of the fuel spray that is injected from the fuel injection valve is gradually increased as the piston approaches the fuel injection valve. The thus-injected fuel spray is appropriately guided into the piston cavity, deflected in the direction toward the ignition plug by the inner wall of the piston cavity, and subject to the stratified charge combustion.

Furthermore, at the late stage (a late stage 1 and a late stage 2), of the injection in the compression stroke, as indicated by FIG. 15D and FIG. 15E, the momentum (the penetration force) of the fuel spray that is injected from the fuel injection valve is gradually reduced as the piston approaches the fuel injection valve. As a result, the increase in the wet amount as shown in FIG. 10D is further reliably suppressed. The thus-injected fuel spray is appropriately guided into the piston cavity, deflected in the direction toward the ignition plug by the inner wall of the piston cavity, and subject to the stratified charge combustion.

As described above, the fuel injection control apparatus according to the fourth mode produces the combustible air-fuel mixture with the favorable combustibility in the vicinity of the ignition plug also at the early stage of the injection in the compression stroke, and reliably suppresses the increase in the wet amount at the late stage of the injection in the compression stroke. Thus, the stable stratified charge combustion can be secured, and the problem of the smoke, the PM, or the like, for example can further reliably be avoided.

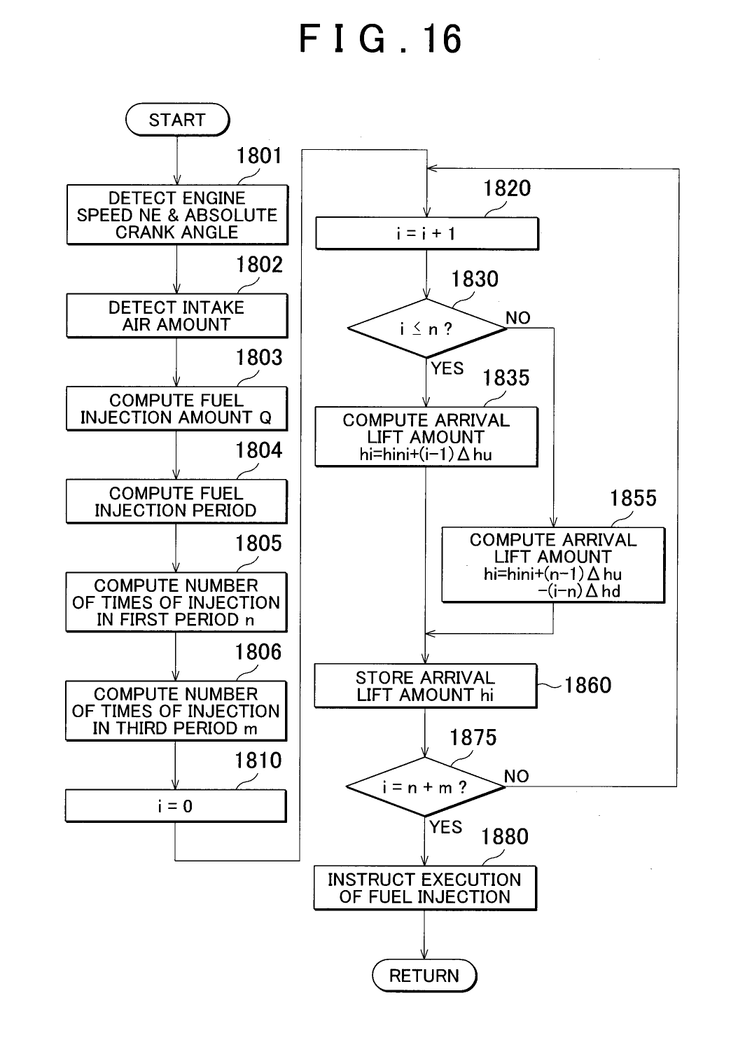

(Fuel injection control flow in the fourth mode) A description will be made on the operation in the fourth mode with reference to a flowchart in FIG. 16. The CPU in the ECU 50 executes routines shown in the flowchart in FIG. 16 at a specified crank angle. Noted that a fuel injection control flow in the fourth mode shown in the flowchart in FIG. 16 differs from the fuel injection control flow in the third mode shown in the flowchart in FIG. 13 only in following one point.

The one point is that, in the fuel injection control flow in the fourth mode, if it is determined in step 1830 that the injection of i time in the compression stroke does not corresponds to the “injection of n time in the first period”, the arrival lift amount is reduced in step 1855 (the detail will be described below). Noted that lower two digits of the number that is assigned to each of the steps corresponds to the content of the routine that is executed in the step. That is, in FIG. 16 and FIG. 13, the same routine is executed in the steps to which the numbers with the same lower two digits are assigned.

Accordingly, similar to the flowchart in FIG. 13, also in the flowchart in FIG. 16, the detection of the engine speed NE, the detection of the intake air amount, the computation of the fuel injection amount Q, the computation of the fuel injection period, the computation of the number of times of injection in the first period n, and the computation of the number of times of injection in the third period m are executed in steps 1801 to 1806. Also in this example, the split injection is performed for the entire fuel injection period that is determined as described above. In the split injection, the arrival lift amount in the injections of n times in the first period is increased as the crank angle of the engine 10 approaches the compression top dead center. In addition, the arrival lift amount in the injection of m times in the third period is reduced as the crank angle of the engine 10 approaches the compression top dead center. Also in this example, the fuel injection period matches the total of the first period and the third period.

Next, the counter i is set to zero in step 1810, and the counter i is counted up in next step 1820. Then, it is determined in step 1830 whether the injection of i time in the split injection corresponds to the “injection of n time in the first period”. If it is determined in step 1830 that the injection of i time corresponds to the “injection of n time in the first period” (step 1830: Yes), the arrival lift amount in the fuel injection of i time is computed in next step 1835. At this time, the arrival lift amount in the fuel injection of the first time is set as hini. Thereafter, the arrival lift amount is increased by the same amount (Δhu) in the fuel injections of the second time to n time. In this case, the arrival lift amount hi in the fuel injection of i time is expressed by the above-described equation (1).

Noted that the arrival lift amount hini in the fuel injection of the first time and the increased amount Δhu of the arrival lift amount in the fuel injections from the second time to n time are set as described above. The arrival lift amounts hi (i=1, 2, 3 . . . , n) in the fuel injections from the first time to n time, which are set just as described, are stored as set values that are used when the next fuel injection is performed, and are stored in the data storage device (the RAM or the like, for example) provided in the ECU 50, for example, in next step 1860.

On the contrary, if it is determined in step 1830 that the injection of i time does not correspond to the “injection of n time in the first period” (step 1830: No), the arrival lift amounts in the fuel injections of i time (from n+1 time to n+m time) are computed in next step 1855. At this time, the arrival lift amounts in the fuel injections for m times from the last time (that is, from n+1 time to n+m time) are reduced by the same amount (Δhd) from the arrival lift amount in the fuel injection of n time. In this case, the arrival lift amount hi in the fuel injection of i time is expressed by the following equation (4).

[Equation 4]

hi=hini+(n−1)×Δhu−(i−n)×Δhd (4)

Noted that the arrival lift amount hini in the fuel injection of the first time and the increased amount Δhu of the arrival lift amount in the fuel injections from the second time to n time are set as described above. The specific reduced amount Δhd of the arrival lift amount in the fuel injections of m times in the third period is set on the basis of the control accuracy of the lift amount of the fuel injection valve 30, the crank angle at the each injection timing (the distance between the fuel injection valve 30 and the piston 17), the engine speed NE, the fuel injection amount Q, and the like, for example. The thus-set arrival lift amount hi in the fuel injection of i time (i=n+1, n+2 . . . , n+m) is stored as a set value that is used when the next fuel injection is performed, and is stored in the data storage device (the RAM or the like, for example) provided in the ECU 50, for example, in next step 1860.

In the next step 1875, the ECU 50 determines whether the arrival lift amount hi is set for all of the fuel injections for n+m times that are performed in the first period and the third period. More specifically, the ECU 50 determines whether i is equal to n+m. If it is determined that i is equal to n+m (step 1875: Yes), the ECU 50 proceeds to next step 1880. At this time, the arrival lift amounts hi for all of the split injections for n+m times are already set and stored in the data storage device. In step 1880, the execution of the fuel injection is instructed on the basis of the fuel injection period that is computed in step 1804, the number of times of injection in the first period n that is computed in step 1805, the number of times of injection in the third period m that is computed in step 1806, and the arrival lift amounts hi that are computed in step 1835 and step 1855 and stored in the data storage device in step 1860.

On the contrary, if it is determined that i is not equal to n+m in step 1875 (step 1875: No), the ECU 50 returns to step 1820. Then, the flow from the step 1820 to step 1875 is repeated. In this way, until the arrival lift amounts hi for all of the split injections for n+m times are set, the flow from step 1820 to step 1875 is repeated.

By the way, in the case where there is no opportunity to inject the fuel other than the split injection in the above first period and third period in the one cycle of the engine 10, needless to say, the number of times of injection in the first period n, the number of times of injection in the third period m, and the arrival lift amount hi for the each injection are set such that the fuel injection amount Q, which is requested per cycle, is equal to the total fuel injection amount in the entire split injection described above. In other words, the number of times of injection in the first period n, the number of times of injection in the third period m, and the arrival lift amount hi for the each injection are set to satisfy the above-described equation (2′).

Noted that the description has been made on the above case where there is no opportunity to inject the fuel other than the split injection in the first period and the third period in the one cycle of the engine 10. However, for example, when it is difficult to inject the fuel injection amount Q, which is requested per cycle, only by the split injection performed in the first period and the third period, the fuel injection may further be performed in a period other than the first period and the third period. For example, as described above, the fuel injection may further be performed in the second period prior to the first period.

Furthermore, the execution orders of the routines that constitute the fuel injection control flow represented by the above flowchart may be switched without causing any contradiction. Moreover, in the above description, the arrival lift amount is increased by the same amount (Δhu) in the fuel injections from the second time to n time. However, the increased amount (Δhu) of the arrival lift amount in the fuel injection from the second time to n time does not always have to be the same and thus may differ each time. Similarly, in the above description, the arrival lift amount is reduced by the same amount (Δhd) in the fuel injections for m times (that is, from n+1 time to n+m time) at the final stage of the split injection. However, the reduced amount (Δhd) of the arrival lift amount in the fuel injection from n+1 time to n+m time does not always have to be the same and thus may differ each time.

In addition, the above description has been made on the case where the injections for m time in the third period are performed immediately after the injections for n time in the first period. However, a period in which the arrival lift amount is maintained to be constant may be provided between the first period and the third period.

As described above, according to the fuel injection control apparatus according to the fourth mode, the arrival lift amount hi in each of the injections that constitute the split injection performed in the first period is set as the larger value as the crank angle of the engine 10 approaches the compression top dead center. Thus, the arrival lift amount is set as the small value in the injection at the early stage of the injection in the compression stroke, at which the distance between the fuel injection valve and the piston is long. In other words, the momentum (the penetration force) of the fuel spray that is injected from the fuel injection valve is small in the injection at the early stage of the injection in the compression stroke. Then, the momentum (the penetration force) of the fuel spray that is injected from the fuel injection valve is gradually reduced as the distance between the fuel injection valve and the piston is reduced at the late stage of the injection in the compression stroke. As a result, it is possible to reduce the momentum (the penetration force) of the fuel spray at the early stage of the injection in the compression stroke and the late stage of the injection in the compression stroke. At the early stage of the injection in the compression stroke, the reduction of the fuel amount that is subject to the stratified charge combustion is concerned when the momentum (the penetration force) of the fuel spray is excessively large. At the final stage of the injection in the compression stroke, the increase in the wet amount is concerned when the momentum (the penetration force) of the fuel spray is excessively large. In addition, the fuel spray with the large momentum (the penetration force) can be injected at the intermediate stage of the injection in the compression stroke. As a result, the stable stratified charge combustion can be secured, and the problem of the smoke, the PM, and the like can further reliably be avoided.

In various embodiments that have been described so far, the case where the fuel injection control apparatus according to the invention is applied to the “internal combustion engine of the side injection type” has been described. However, as described above, the internal combustion engine to which the fuel injection control apparatus according to the invention is applied is not particularly limited as long as the internal combustion engine is the in-cylinder injection spark-ignition internal combustion engine in which the fuel is injected toward the cavity formed in the crown surface of the piston. In other words, the fuel injection control apparatus according to the invention can suitably be applied to, for example, a so-called “internal combustion engine of center injection type” in which the fuel is injected from the fuel injection valve disposed in the vicinity of a central section of the cylinder head toward the cavity formed in the crown surface of the piston, in addition to the “internal combustion engine of the side injection type”.

The description has been made so far on some of the embodiments and the examples with particular configurations occasionally with reference to the accompanying drawings for a purpose of describing the invention. Needless to say, it should not be construed that the scope of the invention is limited to these illustrative embodiments and examples, and modifications can appropriately be made thereto within the scope of the claims and the matters described in the specification.

1. A fuel injection control apparatus for an in-cylinder injection spark-ignition internal combustion engine, the in-cylinder injection spark-ignition internal combustion engine including
a piston provided with a cavity in a crown surface, and
a fuel injection valve configured to inject fuel from an injection hole toward the cavity in conjunction with movement of a valve body from a valve seat, the fuel injection control apparatus comprising
an electronic control unit configured to
i) move the valve body and change an arrival lift amount that is a maximum value of displacement of the valve body,
ii) control the fuel injection valve such that split injection in which the fuel is divided and injected for a plurality of times is executed at least in a first period of a compression stroke of the internal combustion engine,
iii) set the arrival lift amount such that the arrival lift amount for each injection in the first period increases as a crank angle of the internal combustion engine approaches compression top dead center,
iv) cause the fuel injection valve to inject the fuel for a plurality of times in a third period after the first period, and
v) maintain the arrival lift amount for each injection in the third period at a prescribed value.

2. The fuel injection control apparatus according to claim 1 wherein
the electronic control unit is configured to
i) cause the fuel injection valve to inject the fuel at least once in a second period prior to the first period, and
ii) set the arrival lift amount such that the arrival lift amount for each injection in the second period is smaller than the arrival lift amount for an initial injection in the first period.

3. (canceled)

4. (canceled)
